(19) United States
(12) Patent Application Publication
(10) Pub. No.: US 2025/0191110 A1
(43) Pub. Date: Jun. 12, 2025

(54) GRAPHICS PROCESSING SYSTEMS

(71) Applicant: Arm Limited, Cambridge (GB)

(72) Inventors: Jørn Nystad, Trondheim (NO); Tord Kvestad ØYGARD, Trondheim (NO)

(73) Assignee: Arm Limited, Cambridge (GB)

(21) Appl. No.: 18/965,177

(22) Filed: Dec. 2, 2024

(30) Foreign Application Priority Data
Dec. 8, 2023 (GB) 2318804.8

(51) Int. Cl. G06T 1/20

(52) U.S. Cl. CPC G06T 1/20

(57) ABSTRACT

A graphics processing system comprises a programmable processing unit operable to execute processing programs for execution threads corresponding to work items to be processed, and storage 74 in which a respective storage region can be allocated for temporary use by a respective group of execution threads corresponding to a group of work items being executed by the programmable processing unit while the group of execution threads are being executed. 10 Respective indicators (e.g. clear bits) are provided to indicate when respective regions of the storage are to be cleared.

### BACKGROUND

The technology described herein relates to graphics processing systems (and graphics processors), and in particular to the operation of graphics processors/systems when using local storage to (temporarily) store data for a group of execution threads.

Many graphics processors include one or more processing (shader) cores, that execute, inter alia, programmable processing stages, commonly referred to as “shaders”, of a graphics processing pipeline that the graphics processor implements. For example, a graphics processing pipeline may include one or more of, and typically all of: a geometry shader, a vertex shader and a fragment (pixel) shader. These shaders are programmable processing stages that execute shader programs on input data values to generate a desired set of output data, such as appropriately shaded and rendered fragment data in the case of a fragment shader, for processing by the rest of the graphics processing pipeline and/or for output.

It is also known to use graphics processors and graphics processing pipelines, and in particular the shader operation of a graphics processor and graphics processing pipeline, to perform more general computing tasks, e.g. in the case where a similar operation needs to be performed in respect of a large volume of plural different input data values. These operations are commonly referred to as “compute shading” operations, and a number of specific compute APIs, such as OpenCL and Vulkan, have been developed for use when it is desired to use a graphics processor and a graphics processing pipeline to perform general computing operations. Compute shading is used for computing arbitrary information. It can be used to process graphics-related data, if desired, but is also used for tasks not directly related to performing graphics processing.

When performing “shader” processing, a graphics processor shader core will execute a (typically small) program for each “work item” in an output to be generated. In the case of generating a graphics output, such as a render target, such as a frame to be displayed, a “work item” in this regard is usually a vertex or a sampling position (e.g. in the case of a fragment shader). In the case of compute shading operations, each “work item” in the output being generated will be, for example, the data instance (item) in the work “space” that the compute shading operation is being performed on.

In graphics processor shader operation, including in compute shading, each “work item” will be processed by means of an execution thread which will execute the instructions in the shader program in question for the work item in question.

In such arrangements, the work load of the graphics processor is commonly subdivided into respective groups of work items (and correspondingly execution threads), which are correspondingly referred to as “work groups”. A work group is typically a collection of a few dozen to a few hundred execution threads (corresponding to respective work items), that are all guaranteed to exist at the same time (i.e. having the same lifetime) and are able to perform communication and synchronisation with each other (for example using work group-wide barriers). These execution threads are normally but not necessarily, short-lived, with typical lifetimes being dozens to thousands of instructions.

In order to facilitate data sharing between the threads within a work group, a given (and each) work group will typically be allocated a memory region known as “work group local storage” that the threads in the work group can read from and write to. This memory region may be allocated from either normal system memory or from an on-chip resource, and remains available to all threads of the work group for the lifetime of the work group as a whole. When a work group reaches the end of its lifetime, the work group's “local storage” memory region is normally de-allocated, making it available for use by another work group.

The Applicants believe that there remains scope for improved graphics processor/system operation when performing processing for work groups in the above manner.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 shows schematically an embodiment of a graphics processor that can be operated in the manner of the technology described herein;

FIG. 3 shows the work group local storage shared memory;

FIG. 4 shows the work group local storage shared memory in an embodiment of the technology described herein in more detail;

FIG. 5 shows the work group local storage shared memory in an embodiment of the technology described herein in more detail;

FIG. 6 is a flow chart showing a read transaction of an embodiment of the technology described herein;

FIG. 7A is a flow chart showing a write transaction of an embodiment of the technology described herein;

FIG. 7B is an example of implementing a write transaction of an embodiment of the technology described herein;

FIG. 8A is a flow chart showing a write transaction of another embodiment of the technology described herein;

FIG. 8B is an example of implementing a write transaction of an embodiment of the technology described herein;

FIG. 9 shows the work group local storage shared memory in an embodiment of the technology described herein;

FIG. 10 shows the work group local storage shared memory in an embodiment of the technology described herein in more detail;

FIG. 11 is a flow chart showing a write transaction of an embodiment of the technology described herein;

FIG. 12 is a flow chart showing a write transaction of an embodiment of the technology described herein;

FIG. 13 shows the work group local storage shared memory in an embodiment of the technology described herein;

FIG. 14 shows the work group local storage shared memory in an embodiment of the technology described herein in more detail.

Like reference numerals are used for like elements in the Figures where appropriate.

### DETAILED DESCRIPTION

A first embodiment of the technology described herein comprises a graphics processing system, the graphics processing system comprising:
a programmable processing unit operable to execute processing programs for execution threads corresponding to work items to be processed by the graphics processing system; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be “cleared”;
the graphics processing system further comprising a processing circuit that controls memory accesses to the storage, the processing circuit configured to:
when a request is made for an execution thread of a group of work items that is being executed by the programmable processing unit to read data from a respective region of the storage that has been allocated for use by the group of work items:
determine whether a respective indicator associated with the respective region of storage indicates that the region of storage is to be cleared; and
when it is determined based on the associated indicator that the region of storage is to be cleared, return a clear value in response to the request to read the data from the region of storage.

A second embodiment of the technology described herein comprises a method of operating a graphics processing system, the graphics processing system comprising:
a programmable processing unit operable to execute processing programs for execution threads corresponding to work items to be processed by the graphics processing system; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be “cleared”;
the method comprising:
when a request is made for an execution thread of a group of work items that is being executed by the programmable processing unit to read data from a respective region of the storage that has been allocated for use by the group of work items:
determining whether a respective indicator associated with the respective region of storage indicates that the region of storage is to be cleared; and
when it is determined based on the associated indicator that the region of storage is to be cleared, returning a clear value in response to the request to read the data from the region of storage.

The technology described herein relates to graphics processing systems (and graphics processors) that include a programmable processing unit (a “shader core”), that has access to storage that can be allocated for use by “work groups” executing on the programmable processing unit (as discussed above) (“work group local storage”).

As will be discussed in more detail below, the technology described herein provides a particularly efficient mechanism for (at least notionally) clearing respective regions of the (work group local) storage, for example (and in embodiments) when a region of the storage is to be reallocated to a different work group.

This may then enhance the security of the use of the work group local storage, for example by ensuring that data from a previous work group can be (notionally) cleared from a region of storage that has been (previously) allocated for that work group before a new work group starts to use the (same) region of the storage. This can then help prevent different work groups (which may reside in different trust domains) from being able to access each other's data.

The Applicants correspondingly believe therefore that the technology described herein provides an improved arrangement and operation for graphics processors (and graphics processing systems), in particular when using “work group local storage” as shared storage for execution threads in a respective work group.

In particular, according to the technology described herein, respective regions of the (work group local) storage are associated with respective indicators that can be (and are) used to indicate that the associated region of (work group local) storage is all to be “cleared”. These indicators can then be (and are) used to control memory accesses to the associated, respective regions of the (work group local) storage, as will be explained further below, in particular such that when a particular region of the (work group local) storage is indicated to be “cleared” in this way, any previous data that is currently present in the region in question cannot then be accessed (even if the region has not yet been physically cleared).

For instance, when it is determined that a region of the storage should be “cleared” (e.g. because the region is to be allocated for use by a different work group), according to the technology described herein the region does not need to be, and is not, physically cleared at that point, but instead the respective indicator associated with that region is set to indicate that the region is to be (subsequently) cleared. When a respective such indicator is set in this way, this then indicates that the associated region should for the purposes of memory accesses to that region be considered to be “cleared” (even if the underlying data values have not (yet) physically been cleared), and the processing circuit that controls memory accesses to the storage is thus operable and configured to control memory accesses to the storage accordingly based on such indication.

In particular, when a request is made from the programmable processing unit when executing a group of work items to read a data value from a respective region of the storage that has been allocated for use by the group of work items, rather than simply servicing the read request by returning the requested data value from its entry within the respective region of (work group local) storage, e.g. as would normally be done, it is first determined using the respective indicator associated with that region of the (work group local) storage whether or not the region is to be considered to be cleared (e.g. to the particular “clear” value).

So long as the respective indicator associated with the region does not indicate that the region is to be cleared, the read operation can then be performed accordingly, e.g. as normal, with the data value (or values) that is stored at the requested entry (entries) within the region of the storage being returned in response to the request to read the data value from the region of storage.

On the other hand, when it is determined based on the associated indicator for the respective region of the (work group local) storage containing the data value(s) that are the subject of the read request that the region of the storage is to be cleared, the read request should then be (and therefore is) serviced by returning a suitable “clear value” in response to the request to read the data value from the region of storage (i.e. rather than returning the actual data value (or values) stored at the requested entry (entries)).

This then allows all of a region of the (work group local) storage to be (notionally) cleared in a more efficient manner.

The particular “clear value” that is returned in this situation may be any suitable and desired clear value.

For instance, in embodiments, as will be described further below, the indicators can be used to notionally “clear” a region of the (work group local) storage to a predefined, default “same” value (i.e. such that all entries of the region of the region of work group (local) storage should be considered to be cleared to a same, “clear” value), for example, before the region is allocated for use by another work group. Thus, in embodiments, a “same” clear value is returned in response to any (and all) memory access requests to a (and each) respective region of the (work group local) storage that is indicated to be cleared.

Thus, in an embodiment, when a region of the storage is to be cleared, the technology described herein operates to (notionally) clear all entries of the region of the storage to the same clear value. In embodiments, the clear value is zero.

Other arrangements would however be possible and the “clear value” that is used according to the technology described herein can be any suitable and desired value that has the effect of “clearing” the storage region. Thus it should be, and in embodiments is, a value or values that is not (is other than) dependent upon what was already stored in the entry (region) in question. For example, the clear value that is returned when attempting to read data from a region of the (work group local) storage that is indicated to be cleared could be a random value or could, e.g., correspond to the address to which the request relates. The technology described herein may in principle be used to notionally clear a region of (work group local) storage to any suitable “clear” value, which may be a specified, e.g. predefined, “clear” value but could also be any other suitable “clear” value (e.g. a random value) that may be returned in response to a request to read data from a region of the (work group local) storage for which it is indicated that the region is to be cleared.

Thus, by appropriately setting the respective indicator associated with a respective region of the (work group local) storage to indicate that the region is to be cleared (and hence should be considered to be cleared for the purposes of memory accesses (reads) to the region in question), the region in question can be ‘notionally’ “cleared”, when it is desired to do so. This then means that when a request is made from the programmable processing unit when executing a group of work items to read data from a respective region of the storage that has been allocated for use by the group of work items (i.e. there is a ‘valid’ (in “bounds”) read request to the region of the storage that is indicated to be cleared), if the respective indicator associated with that region is set to indicate that the region is to be cleared, a suitable clear value will be returned in response to any (valid) read requests for data values within that region (and in embodiments the same clear value (e.g. zero) will be returned for all read requests to any regions that are indicated to be cleared), without having to physically clear the region of the (work group local) storage at this point (by explicitly writing the clear value to all entries within the region in question, for example).

That is, when a respective indicator is set to indicate that its respective, associated region of the (work group local) storage is to be cleared, this will then cause a suitable clear value to be returned in response to any (valid) requests to read data from that region of the (work group local) storage (and this clear value is returned regardless of what underlying data values may actually be stored at the respective entries in the region of the (work group local) storage).

Accordingly, in the technology described herein, when it is determined that a respective region of the (work group local) storage should be cleared (e.g. so that the region in question can be allocated for use by a different work group), the region is not physically cleared at that point, but instead the respective indicator associated with the region of the (work group local) storage in question is set accordingly to indicate that the region is to be cleared (and should therefore be considered to be cleared for the purposes of memory accesses to the region), and the presence of such indicator then causes a suitable clear value to be returned in response to any subsequent requests to read data values from that region (rather than returning the underlying data that is present at the requested entry within the region in question).

This then means that if the respective indicator for a region of the (work group local) storage has been set in this way, any subsequent requests made from the programmable processing unit when executing a group of work items that has been allocated use of that region of the storage to read data from that region will (for as long as the indicator remains set to indicate that the region is to be cleared) return a suitable clear value, such that the region of (work group local) storage is notionally (albeit not yet physically) cleared, and any subsequent work groups that are allocated the same region of the (work group local) storage will not be able to read the previous work group's data.

If/after the respective indicator for a region of the (work group local) storage has been set in this way, the region of the (work group local) storage can then be (and in embodiments is) physically cleared (or overwritten with new data) when a subsequent request is made to write (new) data to an entry within the region of the (work group local) storage.

That is, after the region of (work group local) storage is de-allocated/reallocated for use by a different (new) work group, the region of (work group local) storage is not immediately physically cleared, but instead the indicator is set to indicate that the region is to be cleared, and this causes the region to be treated as being cleared for the purposes of any read requests that may be made from the new work group. The new work group will typically at some point need to write some data to its allocated work group local storage and the (entire) region of (work group local) storage should be, and in embodiments, is therefore cleared or otherwise overwritten with new data for subsequent use by the new work group, at that point (and various mechanisms are contemplated for ensuring that all of a region of the (work group local) storage is cleared/overwritten, as will be explained further below). Correspondingly, the respective indicator associated with that region can and should be updated at that point, alongside, or as part of, the write operation, to indicate that the region no longer should be treated as ‘to be cleared’ (i.e. as all of the (work group local) storage will have been cleared or overwritten at this point).

Thus, when a request is made from the programmable processing unit when executing a group of work items to write a data value to a respective region of the storage that has been allocated for use by the group of work items, it is first checked whether or not the respective indicator associated with the region in question has been set to indicate that the region is to be cleared. If no such indication is present (i.e. the indicator does not indicate that the region is to be cleared), the write operation can be performed as normal, e.g. by writing the (new) data value (or values) to the requested entry (entries). Whereas, when the indicator associated with the region indicates that the region is to be cleared, rather than simply servicing the write operation by writing the requested value(s) to the requested data entry (entries), all of the region of the (work group local) storage is in embodiments physically cleared or otherwise overwritten with new data so that any data from a previous work group is cleared at this point.

Various arrangements would be possible in this regard.

For example, in some embodiments, when a request is made from the programmable processing unit when executing a group of work items to write data to a respective region of the storage that has been allocated for use by the group of work items, and when the respective indicator associated with the region in question is set to indicate that the region is to be cleared, the region may first be explicitly cleared (e.g., and in embodiments by writing a suitable (and in embodiments the same) clear value to all entries/locations within the region), and once the region has been cleared, the write operation may then be performed.

This can work well to ensure the region of (work group local) storage is appropriately cleared for subsequent use by the current work group. However, the Applicants recognise that this may be relatively inefficient as in this case at least an additional step is required in order to clear all of the region before the requested write can then be performed.

Thus, in embodiments, when a request is made from the programmable processing unit when executing a group of work items to write data to a respective region of the storage that has been allocated for use by the group of work items, and when the respective indicator associated with the region in question is set to indicate that the region is to be cleared, the write operation is performed by writing the (new) data value (or values) to the requested entry (or entries), and writing the (same) clear value to any (all) other entries within the (same) region (assuming that the original write operation does not overwrite the entire region), and this is in embodiments done in a single step.

Thus, when a request is made from the programmable processing unit when executing a group of work items to write a data value to a respective region of the storage that has been allocated for use by the group of work items, and when the respective indicator associated with the region in question is set to indicate that the region is to be cleared, if the write operation overwrites all of the region of the (work group local) storage, the write operation can proceed as normal (and in this case there is no need to explicitly clear the region as all of the region will be overwritten in one go). However, it is often the case that the write operation will write to less than all of the region of the (work group local) storage. In this situation, any other entries (that are not being overwritten) should have a suitable (and in embodiments the same) clear value written at this point, and this is in embodiments therefore done.

Thus, if the write overwrites the entire region, the write can be serviced as normal, and the (new) data values written to the region without ever having to physically clear the region in question. However, if the write affects less than all of the region in question, any other entries (that are not being written to) should be cleared at this point by explicitly writing a suitable (and in embodiments the same) clear value into those entries at this point.

That is, a request to write data to a region of the (work group local) storage for which it is indicated that the region is to be cleared should (and in embodiments does) clear or overwrite all of the region, and this is in embodiments done in a single step regardless of how much of the region the write transaction actually affects. Various arrangements are contemplated in this regard for clearing all of the region in this situation, e.g. depending on the configuration of the (work group local) storage as will be explained further below.

As mentioned above, the respective indicator associated with the region of the (work group local) storage should then be (and in embodiments is) also updated at this point to indicate that the region is no longer to be considered to be cleared for the purposes of memory accesses (since at this point the previous work group's data have been overwritten or cleared as appropriate, such that the region has been effectively cleared). This updating is thus performed alongside servicing the write operation (although the actual updating could be done before or after the write operation has actually been performed.)

The effect and benefit of all this therefore is to allow a very fast (notional) clearing of whole regions of the (work group local) storage (in embodiments to a common, “clear” value (e.g. to zero)).

For instance, by setting the respective indicator associated with a respective region of the (work group local) storage to indicate that the region is to be cleared, the region can then be treated as being cleared for the purposes of any read requests, e.g., and in embodiments, without having to physically overwrite the data values stored in that region of (local) storage at the point at which it is determined that the region should be cleared, and the region will then be physically cleared (or overwritten) when a subsequent request is made to write (new) data to that region. As will be explained further below, a respective indicator may be associated with a relatively larger region of the (work group local) storage, which entire region can then be (notionally) cleared in one go by setting the respective indictor accordingly.

(In contrast, in more traditional graphics processors/systems, no specific mechanism is provided for allowing regions of the (work group local) storage to be cleared between work group allocations, and so in order to do this, the programmer would typically have to include at the start of a program for a work group a number of instructions to explicitly write the desired clear values to all entries within its allocated work group (local) storage. This can however require a number of processing cycles and so may be less efficient than the mechanism provided by the technology described herein. Further, this relies on the programmer doing this.)

The technology described herein thus provides a particularly efficient mechanism for (notionally) clearing regions of (work group local) storage that can be implemented within the graphics processor (hardware) thus ensuring that regions of the (work group local) storage can be notionally cleared when it is desired to do so, without requiring the programmer to explicitly do so.

For instance, as mentioned above, the technology described herein may find particular benefit and utility in clearing regions of (work group local) storage, e.g. so that the region of the (work group local) storage can then be reallocated for use by a different work group.

(However, in principle, it may be desired to clear a particular region of storage at any time, e.g. within a shader program, and the operation according to the technology described herein can generally be used accordingly for any such situations where it may be desired to notionally “clear” all of a region of the (work group local) storage.)

In this respect, the Applicants have recognised that being able to (notionally) clear regions of (work group local) storage in the manner of the technology described herein may be particularly beneficial in the situation where a particular work group has finished its processing, so that its work group (local) storage can be (and is to be) reallocated for use by a different work group.

In this respect, the Applicants further recognise that different work groups may operate in different trust domains (e.g. if they originate from different applications/processes and/or virtual machines), and that it may therefore be beneficial to be able to (notionally) clear work group (local) storage before that storage is reallocated for use by a different work group. This may then enhance the security of the use of the work group (local) storage, for example by ensuring that data from a previous work group is (notionally, if not necessarily physically) cleared before a new work group starts to use the region of the storage in question, and the technology described herein provides a particularly efficient mechanism to do this within the graphics processor (hardware) thus ensuring that regions of the (work group local) storage can be (notionally) cleared when it is desired to do so (without requiring the programmer to do so, and so mitigating against malicious programs that may attempt to access data across different trust domains).

The clear process of the technology described herein (i.e. the setting of the respective indicators to indicate that a respective, associated region of the (work group local) storage is to be cleared) can thus be invoked and triggered in any suitable and desired manner.

In an embodiment, the clear process is (at least) triggered (and performed) when a storage region for a work group in the (local) storage is to be de-allocated (on work group de-allocation). In this case, in an embodiment, the clear process is triggered upon the work group region de-allocation event (which may be triggered in any suitable and desired manner, such as, and in embodiments, in the normal manner for the graphics processor and graphics processing system in question), but with the de-allocation itself then not being performed until the clear process has finished (i.e. the respective indicators have been set to indicate that the region that is being de-allocated is to be cleared). This should then ensure that the region allocated to the work group (that is being de-allocated) will be cleared before that region is made available by use by another work group. In this case, it would also be possible, for example, to provide a user-space control to allow the programmer (e.g.) to indicate whether a work group local storage region should be “post-cleared” when it is de-allocated, or not.

(The de-allocation of a region of the local storage after/from use by a work group (which may trigger setting of the indicators that the region is to be cleared) can be performed in any suitable and desired manner, and is in embodiments performed in the normal manner for deallocating work group local storage in the graphics processor and graphics processing system in question.)

In an embodiment, the clearing process (i.e. the setting of the respective indicator(s)) can also or instead (and in embodiments also), and in embodiments is, (at least) triggered (and performed) when a new allocation of a storage region for a new work group is made in the (local) storage in question. Thus, in an embodiment, when a new local storage region allocation for a (new) work group is made, the respective indicator associated with that region of (work group local) storage is correspondingly and in embodiments set to indicate that the (newly allocated) local storage region in question should be considered to be cleared to the default value before it is used by (execution threads for) the work group in question.

(The allocation of a region of the local storage to a work group (for use by a work group) (which may then trigger the clearing operation) can be performed in any suitable and desired manner, and is in embodiments performed in the normal manner for allocating work group local storage to a work group in the graphics processor and graphics processing system in question.)

The clear process (setting of the respective indicator(s)) in this case could be triggered by any suitable and desired element of the graphics processor and graphics processing system. For example, the circuit and process that allocates/de-allocates local storage regions for work groups could also be configured to appropriately trigger the clear process (setting of the respective indicator(s)) when it allocates/de-allocates a storage region for a work group.

In an embodiment, the clear process (setting of the respective indicator(s)) that is performed when a new local storage region allocation for a new work group is made (i.e. the setting of the respective indicators) is triggered by the process and circuit that generates the execution threads for the work group in question (which thread creation process circuit then, in embodiments, correspondingly causes an update to the respective indicator (or indicators) associated with the region(s) of the storage that are being allocated for the new work group).

Thus, in an embodiment, the thread (warp) manager (management circuit) is configured to and operable to send appropriate signals/messages to trigger updating of the respective indicator(s).

(It will be appreciated in this respect that although the thread (warp) manager (management circuit) may trigger and control the updating of the respective indicator(s), the indicators themselves will typically, and in embodiments, be stored closer to the logic that accesses the (work group local) storage, as will be explained further below. Thus, for example, the thread (warp) manager (management circuit) may signal to the overall storage (memory) unit including the (work group local) storage to update the respective indicator(s) covering the region of the (work group local) storage that is allocated for temporary use by the work group that the thread (warp) manager (management circuit) is currently creating. The signal that is sent in this respect may be any suitable signal that can be used to identify the respective (addresses of the) regions that are to be cleared.)

Thus, in an embodiment, the thread group (warp) manager (management circuit) is configured to and operable to update the respective indicator associated with a region of the (work group local) storage, and in embodiments does so in response to it creating (the creation of) a new work group for execution.

The clear process (updating of the respective indicator(s)) in the case of an “allocation” operation could in this regard be triggered (the signal sent to update the respective indicator(s)) at any appropriate point in the work group “creation” or allocation process. For example, it could be triggered directly following a point when the work group local storage gets allocated. Alternatively, the clear process could be triggered when the first access to the work group local storage region is made (with the access correspondingly being stalled appropriately). The allocation of the work group local storage can correspondingly be performed at any suitable and desired point in the process, for example when it is known that the work group will be run (at some point) or, for example, once threads for the work group start to be created, or after thread creation.

Thus, the clear process could in this regard be triggered (the signal sent to update the respective indicator(s)) at any appropriate point in the work group “creation” process, for example once the thread group manager is aware that a new work group is to be created, or once the work group has been created but before the necessary execution threads have been issued for execution, etc., as desired.

The clear process of the technology described herein (i.e. the setting of the respective indicators to indicate that a respective, associated region of the (work group local) storage is to be cleared) could thus be triggered whenever there is local storage allocation for a new work group (and in one embodiment that is what is done).

However, the Applicants have recognised that it may not be necessary to first “clear” local storage to be used for a work group in the case where the storage region was previously used by a work group from the same trust domain as the new work group (e.g. for the same process/application and/or virtual machine, etc., as the previous work group).

Thus, in an embodiment, the clearing process (i.e. the updating of the indicator so as to indicate that its associated region of the storage is to be cleared) is triggered in response to allocation of a region in the local storage for a new work group when the storage region in question is being allocated (all or in part) to a work group from a different trust domain, but is not triggered (is other than triggered) when the (entirety of the) storage region in question is being allocated to another work group from the same trust domain.

In embodiments this check and the triggering of the clearing process is done in a conservative manner, i.e. such that the clearing process will be triggered when it cannot be proven that the new work group that the local storage region is being allocated to comes from the same trust domain (i.e. such that the clearing process will be triggered unless and only when it can be determined with certainty that the new work group that the local storage region has been allocated to comes from the same trust domain as the previous work group that used that region).

In these arrangements, a change of trust domain between work groups can be determined/identified in any suitable and desired manner, for example, and in embodiments, in the normal manner for identifying and/or assuming trust domain changes in the graphics processor and graphics processing system in question.

Correspondingly, the allocation of a region of the local storage to a work group (for use by a work group) (which may then trigger the clearing operation) can be performed in any suitable and desired manner, and is in embodiments performed in the normal manner for allocating work group local storage to a work group in the graphics processor and graphics processing system in question.

Thus, in embodiments, the respective indicator associated with a region of storage is set to indicate that the associated region of storage is to be cleared to the particular clear value when (and in embodiments whenever) there is a change in trust domain between groups of work items for which the region of storage has been allocated for use by.

The technology described herein may therefore provide various benefits compared to other possible approaches in terms of enhanced data security when using such work group (local) storage to (temporarily) store data for work groups.

For example, as mentioned above, in more traditional graphics processor/system arrangements, no such mechanism for clearing work group (local) storage between work groups was provided, such that there is a risk that data from an earlier work group may be accessible by another, later work group via the work group (local) storage when the later work group is allocated the same region of the (work group local) storage for use that was allocated for use by the earlier work group. By providing a mechanism for (notionally) clearing regions of the (work group local) storage between work group allocations, the technology described herein thus avoids this situation and provides enhanced security.

Further, the clearing processing in the technology described herein can be performed in a relatively efficient (e.g. faster) manner.

The technology described herein also extends to a graphics processor for use within a graphics processing system as described above.

Another embodiment of the technology described herein, therefore, comprises a graphics processor, the graphics processor comprising:
a programmable processing unit operable to execute processing programs for execution threads corresponding to work items to be processed by the graphics processor; and
a processing circuit that controls memory accesses to storage in which a respective region of the storage can be allocated for temporary use by a respective group of execution threads corresponding to a group of work items being executed by the programmable processing unit while the group of execution threads are being executed, wherein respective regions of the storage are associated with respective indicators that can be used to indicate that all entries of the associated region of storage are to be cleared;
the processing circuit configured to:
when a request is made for an execution thread of a group of work items that is being executed by the programmable processing unit to read data from a respective region of the storage that has been allocated for use by the group of work items:
determine whether a respective indicator associated with the respective region of storage indicates that the region of storage is to be cleared; and
when it is determined based on the associated indicator that the region of storage is to be cleared, return a clear value in response to the request to read the data from the region of storage.

Correspondingly, yet another embodiment of the technology described herein comprises a method of operating a graphics processor, the graphics processor comprising:
a programmable processing unit operable to execute processing programs for execution threads corresponding to work items to be processed by the graphics processor,
the method comprising:
when a request is made for an execution thread of a group of work items that is being executed by the programmable processing unit to read data from a respective region of storage that has been allocated for temporary use by a respective group of execution threads corresponding to the group of work items, wherein respective regions of the storage are associated with respective indicators that can be used to indicate that all entries of the associated region of storage are to be cleared:
determining whether a respective indicator associated with the respective region of storage indicates that the region of storage is to be cleared; and
when it is determined based on the associated indicator that the region of storage is to be cleared, returning a clear value in response to the request to read the data from the region of storage.

As will be appreciated by those skilled in the art, these embodiments of the technology described herein can and in embodiments do include any one or more or all of the optional features of the technology described herein described herein, as appropriate.

The graphics processing system can be any suitable and desired graphics processing system that includes a programmable processing unit that can execute program instructions.

The programmable processing unit of the graphics processing system can be any suitable and desired programmable processing unit (“core”) that is operable to execute (shader) programs.

The programmable processing unit is in embodiments part of a graphics processor of the graphics processing system. Thus, the system in embodiments comprises a graphics processor comprising the programmable processing unit. The graphics processor can be any suitable and desired graphics processor that includes a programmable processing unit that can execute program instructions.

The graphics processor/system may comprise a single programmable processing unit, or may have plural such units. Where there are a plural programmable processing units, each processing unit can, and in embodiments does, operate in the manner of the technology described herein.

Where there are plural programmable processing units, each unit may be provided as a separate circuit to other programmable processing units of the graphics processor/system, or the programmable processing units may share some or all of their circuits (circuit elements).

The (and each) programmable processing unit should, and in embodiments does, comprise appropriate circuits (processing circuits/logic) for performing the operations required of the programmable processing unit.

Thus, the (and each) programmable processing unit will, for example, and in embodiments does, comprise an instruction execution circuit (execution engine) operable to, and configured to, execute program instructions for execution threads. This instruction execution circuit (engine) should, and in embodiments does, comprise a set of at least one functional unit (circuit) operable to perform data processing operations for an instruction being executed by an execution thread. An execution unit (engine) may comprise only a single functional unit, or could comprise plural functional units, depending on the operations the execution unit (engine) is to perform.

In an embodiment, the graphics processor/system and the programmable processing unit is operable to execute (shader) programs for sets (“warps”) of plural execution threads together, e.g. in lockstep, one instruction at a time.

(It will be appreciated here that a “work group” thus typically, and in embodiments, will contain a plurality of such execution thread groups (“warps”). Thus, a “work group” in embodiments comprises a plurality of such execution thread groups (“warps”) that in embodiments all have access to the work group (local) storage that is allocated for that work group.)

In this case the functional units, etc., of a given execution unit are in embodiments configured and operable so as to facilitate such thread warp arrangements. Thus, for example, the functional units are in embodiments arranged as respective execution lanes, one for each thread that a thread warp may contain.

The (programmable processing unit of the) graphics processor in embodiments also comprises any other appropriate and desired units and circuits required for the operation of the programmable processing unit(s), such as appropriate control circuits (control logic) for controlling the execution unit(s) (engine) to cause and to perform the desired and appropriate processing operations.

Thus the (programmable processing unit of the) graphics processor/system in embodiments also comprises an appropriate thread (warp (set)) manager (controller) circuit (a “warp manager”) that is operable to issue sets (warps) of threads to the execution unit (engine) for execution and to control the scheduling of sets (warps) of threads on/to the execution unit (engine) for execution.

The thread (warp) manager in embodiments comprises an execution thread generator (spawner) circuit that generates (spawns) (warps of) threads for execution; and an execution thread scheduler circuit that schedules (warps of) threads for execution (this may be part of the thread generator).

The graphics processor/system in embodiments also comprises and/or has access to appropriate (local) storage, such as registers/register file, caches, etc., and an appropriate interface to, and communication with memory (a memory system) of or accessible to the graphics processor/system (e.g., and in embodiments, via an appropriate cache hierarchy), together with appropriate load/store units and communication paths for transferring data between the local storage and memory system of or accessible to the graphics processor/system.

The memory and memory system is in embodiments a main memory of or available to the graphics processor/system, such as a memory that is dedicated to the graphics processor/system, or a main memory of a data processing system that the graphics processor/system is part of.

The storage that is used to (temporarily) store data for execution threads for work groups in the technology described herein (the storage that is used for “work group local storage”) can be any suitable and desired storage of or available to execution threads when executing on the programmable processing unit (of the graphics processor/system).

This storage is intended to be storage (memory) via which execution threads for respective work groups can communicate values to other threads in the work group, but which is to be allocated for use by threads of a work group temporarily (and so will be reused from one work group and/or process to another).

It is different therefore, for example, to storage (e.g. system memory) that is to be used to “transfer” data values between different work groups, processes, and/or components of the overall data processing system. Rather, it is intended to be, and is, local and temporary storage (memory) that is used for work groups and that can be allocated for use by work groups, but which then will be de-allocated from a work group in question (and available for use by another work group) once a work group has terminated.

Thus the storage that is used for “work group local storage” in the technology described herein is intended to be, and to act and to be used as, a “scratch pad memory”, for use by work groups executing on the programmable processing unit.

The allocation of storage regions within the “work group local storage” to respective work groups being executed by the programmable processing unit can be performed in any suitable and desired manner. In an embodiment, this is done in the normal manner for the allocation of work group local storage for the graphics processor and graphics processing system in question.

In an embodiment, respective regions of the storage may be (and are) allocated to plural different work groups at the same time, i.e. such that there will be plural different “work group local storage” regions allocated to different work groups in the storage at the same time (and these plural different work groups may reside in different trust domains, e.g. where the different work groups belong to different applications/processes and/or virtual machines, etc. for which graphics processing is being performed at the same time). It could also, e.g., be the case that any given work group's work group local storage in the storage comprises plural distinct (separate) regions in the storage, if desired.

The storage that is used for the “work group local storage” may comprise storage that is dedicated to and specifically set aside for the purposes of providing “work group local storage” (and in one embodiment that is the case), or it may comprise storage that as well as being intended to be used as “work group local storage”, is also available to be used for other purposes, such as by other processes that the graphics processor/system may perform (and in another embodiment this is the case).

In the latter case, the storage that is to provide the “work group local storage” and that the clearing process of the technology described herein can be controlled to “clear” will accordingly have plural “requesters” (“masters”) able to access it, comprising at least execution threads and the corresponding processes and circuits that are using the “shared” storage for “work group local” storage, and other processes and circuits that are using the storage for other purposes.

The storage that provides the work group local storage may be configured as desired, e.g. as a single bank of storage. In an embodiment, the storage is configured as multiple, independently accessible (memory) banks (e.g. to allow more than one memory access per clock cycle).

In the case where storage (whether dedicated to work group local storage or otherwise) is configured across multiple (memory) banks, then in an embodiment, each storage (memory) bank has its own accessor circuit that controls memory accesses for execution threads of work groups that are currently being executed by the programmable processing unit, with each accessor circuit (in embodiments) operable and configured to operate independently for its respective storage bank (once started). For instance, each accessor circuit may maintain a respective queue of memory accesses (transactions) to be serviced for execution threads of work groups that are currently being executed by the programmable processing unit relating to its respective storage (memory) bank.

The storage that provides the work group local storage (and that the clearing process of the technology described herein is controllable to clear) can be provided as desired in the graphics processing system.

In an embodiment, it is storage that is local to (on-chip with) the graphics processor, and in embodiments local to and on-chip with the programmable processing unit of the graphics processor/system. Thus, the storage is in embodiments storage that provides a faster, more efficient and higher bandwidth path (from the instruction execution circuit of) the programmable processing unit, than, for example, memory of the train) memory system or available to the graphics processor/system.

Correspondingly, in an embodiment, the system comprises a graphics processor that comprises both the programmable processing unit and the storage that is used for (that provides) the “work group local storage”.

Correspondingly, the storage in embodiments does not form (is not) part of a cache hierarchy or (main) memory (system), and in embodiments does not require communication over any communication buses external to the graphics processor and/or programmable processing unit to be accessed by/for a work group executing on the programmable processing unit.

Thus, a further embodiment of the technology described herein comprises a graphics processor, the graphics processor comprising:
a programmable processing unit operable to execute processing programs for execution threads corresponding to work items to be processed by the graphics processor; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be “cleared”;
the graphics processor further comprising a processing circuit that controls memory accesses to the storage, the processing circuit configured to:
when a request is made for an execution thread of a group of work items that is being executed by the programmable processing unit to read data from a respective region of the storage that has been allocated for use by the group of work items:
determine whether a respective indicator associated with the respective region of storage indicates that the region of storage is to be cleared; and
when it is determined based on the associated indicator that the region of storage is to be cleared, return a clear value in response to the request to read the data from the region of storage.

Correspondingly, a yet further embodiment of the technology described herein comprises a method of operating a graphics processor, the graphics processor comprising:
a programmable processing unit operable to execute processing programs for execution threads corresponding to work items to be processed by the graphics processor; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be “cleared”;
the method comprising:
when a request is made for an execution thread of a group of work items that is being executed by the programmable processing unit to read data from a respective region of the storage that has been allocated for use by the group of work items:
determining whether a respective indicator associated with the respective region of storage indicates that the region of storage is to be cleared; and
when it is determined based on the associated indicator that the region of storage is to be cleared, returning a clear value in response to the request to read the data from the region of storage.

As will be appreciated by those skilled in the art, these embodiments of the technology described herein can and in embodiments do include any one or more or all of the optional features of the technology described herein described herein, as appropriate. That is, the clearing process (i.e. the setting and use of the respective indicator(s) associated with the regions of the storage) is in embodiments performed in the same way described above regardless as to whether the storage is (entirely) local to (on-chip with) the graphics processor, and in embodiments local to and on-chip with the programmable processing unit of the graphics processor, or otherwise.

Other arrangements would, of course, be possible.

As discussed above, in the technology described herein, respective regions of the (work group local) storage are associated with respective indicators that can be used to indicate that the associated region of storage (in its entirety) is to be cleared to a particular clear value (with these indicators thus being used to control the clearing process according to the technology described herein, e.g. as described above).

Subject to the particular requirements of the technology described herein these indicators may generally take any suitable and desired form but in an embodiment these indicators comprise respective (sets of) “clear bits” that are associated with respective regions of the (work group local) storage. In embodiments, a (and each) respective region of the (work group local) storage is associated with a respective single such clear bit that can be set/cleared appropriately to control the clearing process of the technology described herein.

Thus, when the clear bit associated with a particular region of the (work group local) storage is set to a first value (e.g. to ‘1’), this indicates that the associated region is to be cleared to the particular clear value (and so is treated as being cleared to the particular clear value for the purpose of memory accesses (e.g. reads) to that region). Whereas, when the clear bit associated with a particular region of the (work group local) storage is set to a second value (e.g. to ‘0’), this indicates that the region should be treated as normal.

Other arrangements would however be possible. For example, in other examples, the indicators may in addition to indicating whether (or not) an associated region of the (work group local) storage is to be cleared may also indicate various other information, in which case larger data structures may be required. For instance, in some embodiments, the indicator may in addition to indicating whether (or not) an associated region of the (work group local) storage is to be cleared also indicate a respective clear value that the region is to be cleared to (and this may then allow the region to be cleared to an arbitrarily specified clear value). For example, in embodiments, the indicators may be able to indicate, for their respective region, which clear value from a set of available (predefined) clear values should be used for that region. It would also be possible for the indicator data structure to indicate a particular clear scheme that is to be used, e.g., so that a suitable random value, or address, for example, is returned in response to requests to read data from a region for which it is indicated that the region is to be cleared (and similarly so that a suitable random value, or address, for example, is written to any entries/locations within the region that need to be physically cleared in response to requests to write (new) data to a region for which it is indicated that the region is to be cleared), as briefly mentioned above. Various examples would be possible in this regard.

The indicators, in whatever form they take, may be stored in any suitable and desired manner, e.g. so long as they can be suitably associated with respective regions of the (work group local) storage. In an embodiment, the indicators may be stored using registers/register files available to the programmable execution circuit that is processing the work group. However, subject to the particular requirements of the technology described herein, e.g. so long as the indicators can be suitably accessed and updated as needed according to the technology described herein (and in embodiments cannot otherwise be modified), various other arrangements would be possible for storing the indicators. For example, the indicators could be stored in a separate storage unit or in (another) portion of the storage that provides the (work group local) storage.

In general, the respective indicators (“clear bits”) may be associated with any suitably defined regions of the (work group local) storage.

In embodiments, the (size of the) regions for which respective indicators are provided are selected to align with the allocation of work group (local) storage. That is, it in embodiments is the case that the work group (local) storage that can be allocated for use by a particular work group corresponds to an integer number (one or more) of the regions that the clearing process of the technology described herein can be used to (notionally) clear (i.e. the respective regions for which respective indicators are provided). This may simplify the clearing process (i.e. the updating and using of the respective indicator(s)) according to the technology described herein.

Various arrangements would, however, be possible for associating indicators with respective regions, e.g. depending on the configuration of the storage that is being used to implement the work group local storage.

For example, as mentioned above, in embodiments, the storage is configured as multiple, independently accessible (memory) banks, (e.g. to allow more than one memory access per clock cycle).

In that case, respective (individual) indicators may be associated with regions of the storage within a single such storage (memory) bank. In that case, each individual storage (memory) bank may have its own set of indicators (“clear bits”) covering respective regions within that storage (memory) bank, such that it can be independently indicated for individual regions within a single storage (memory) bank whether or not the region should be considered to be cleared.

In this situation, where the indicators are only associated with a single such storage (memory) bank, the clearing process may be relatively simpler since the (notional) clearing for each storage (memory) bank can be (and is) controlled independently (e.g. without any need to synchronise the clearing process across multiple independently accessible storage (memory) banks). That is, in the situation where each storage (memory) bank has its own set of indicators (“clear bits”) covering respective regions within that storage (memory) bank, a request to access data from one of the regions within a particular storage (memory) bank will (only) be processed by the respective accessor circuit for that particular storage (memory) bank. Thus, a request to write data to a region within a particular storage (memory) bank will (only) be processed by the respective accessor circuit for that particular storage (memory) bank, and, as described above, once the write operation has been performed, the respective indicator associated with that region can then be updated (cleared) accordingly, independently of the state of the respective indicators for any of the other storage (memory) banks.

In this situation, it may be the case that a given request to write new data to a region for which it is indicated that the region should be cleared will request to write data to less than all of the region. However, in that case, the original write operation may be suitably ‘widened’, e.g., and in embodiments, so that in addition to writing the new data value (or values) to the (originally) requested entries within the region, the (same) write operation writes a suitable clear value (e.g. zero) to all other entries within the region of the (work group local) storage in question. In the case where the respective indicators are associated with respective regions that reside within a single storage (memory) bank (having a respective accessor circuit), this widening may, for example, be performed by the respective accessor circuit for that storage (memory) bank. Other arrangements would however be possible and in general this widening may be performed by any suitable entity along the appropriate access path within the graphics processor/system.

Thus, in some embodiments, the storage is configured as multiple, independently accessible banks, and each storage bank has its own set of indicators.

In an embodiment, however, the respective indicators cover respective regions of the storage that extend across multiple (e.g. all) of the storage (memory) banks. In that case, a single indicator can be used to clear a (relatively larger) region of (work group local) storage that is configured across multiple storage (memory) banks. This may be desirable since this allows larger regions of the (work group local) storage, extending across multiple of the storage (memory) banks to be allocated for use by a particular work group, and then (notionally) cleared using the techniques of the technology described herein, but without the additional area cost of providing separate respective indicators in respect of each of the different storage (memory) banks, for example.

Thus, in embodiments, the storage is configured as multiple, independently accessible banks, and the respective indicators are associated with respective regions of the storage that extend across multiple of the independently accessible banks.

However, this then means that the clearing process may in turn need to be synchronised across multiple, independent storage (memory) banks.

For example, as mentioned above, when a respective indicator is set to indicate that an associated region of the storage is to be cleared, that region may (and generally will) be physically cleared or overwritten in response to a subsequent request to write data for an execution thread of a work group that has been allocated that region for use as its work group local storage.

In that case, if the request to write data writes data to all of the independent storage (memory) banks in the region of the storage in question, a respective write transaction will correspondingly be processed by each respective accessor circuit (i.e. for each of the storage (memory) banks in question). The clearing process can therefore work essentially as described above, but with each write transaction (per-bank) being ‘widened’ if necessary to ensure that all of the region is overwritten/cleared as appropriate.

However, as also mentioned already above, it may often be the case that a request to write data to a particular region will write data to less than all of the region in question. Thus, when the storage is configured as multiple, independently accessible banks, a request to write data may, and often will, write data to less than all of the storage (memory) banks that the region extends across. This then means that the request to write the data may correspondingly generate write transactions for less than all of the accessor circuits (i.e. the write transaction may only be added to the respective transaction queue (or queues) for the storage (memory) bank(s) to which the original write request relates). In order to ensure the correct clearing behaviour when the indicator is set to indicate that the region is to be, the write request should still cause all of the region to be cleared to a suitable clear value in a synchronised manner, and so in embodiments additional mechanisms are provided so that this can be (and is) done.

There are various arrangements possible in this regard.

For example, in some embodiments, in the situation where a request to write a data value (or set of data values) to a region of the (work group local) storage for which the respective indicator indicates that the region is to be cleared to the particular clear value is received, and where the region extends across multiple, independently accessible storage (memory) banks, wherein the write request affects less than all of the storage (memory) banks, the write operation may again effectively be ‘widened’, e.g., in the same manner described above, so that in addition to writing the desired data value (or values) to the (originally) requested entries, the (same) write operation in embodiments writes a particular clear value (e.g. zero) to all other entries (for all of the storage (memory) banks) within the region of the (work group local) storage in question.

Thus, in some embodiments, when a request is made for an execution thread of a group of items to write new data to one or more entries within a respective region of the storage that has been allocated for use by the group of work items, but wherein the request is to write new data to less than all of the entries within the respective region of the storage, when it is determined based on the associated indicator that the region of storage is to be cleared: the processing circuit that controls memory accesses to the storage is configured to (and the method comprises steps to) perform a write operation that writes the new data to the requested entries within the region of the storage and also writes a clear value to all other entries within the region of the storage.

In this approach the original write operation that would be performed to service the write request is therefore effectively ‘widened’ so that a new widened write transaction is generated for performing a write operation that writes the new data to the requested entries within the region of the storage and also writes a clear value to all other entries within the region of the storage (and this is in embodiments a single write operation, e.g. that is performed within a single access cycle). This approach then allows all entries within a region of storage to be overwritten/cleared as appropriate with a single write operation, even when the region of storage extends across multiple storage (memory) banks.

The approach described above where the write transaction is effectively ‘widened’ so that all of the region of storage is overwritten by a single write operation thus works well when each storage (memory) bank has its own set of indicators (such that write transactions to a particular region are in embodiments processed independently, via the respective accessor circuits for the storage (memory) bank including the region in question). This approach can also work well to synchronise the clearing process across different storage (memory) banks at least where the (work group local) storage is dedicated to and specifically set aside for the purposes of providing “work group local storage” (as is the case in some embodiments), e.g. so that the write operation can be performed across all storage (memory) banks in a single cycle ensuring that all of the region that is to be cleared is cleared in one go.

However, as mentioned above, it may be the case that the storage that is being used as the “work group local storage”, is also available to be used for other purposes, such as by other processes that the graphics processor may perform (and this is the case in other embodiments). In that case, there may be plural, different “accessors” (“masters”) that may attempt to access the storage in question. This may then lead to the different accessor circuits (for the different storage (memory) banks) losing synchronisation with each other.

For instance, in the case where the (work group local) storage is also shared with another unit or units (or process or processes) that is able to use the storage (in addition to the storage being used for work group local storage for work groups being executed by the programmable processing unit), then in an embodiment, the system (e.g. graphics processor) includes an appropriate) arbitration circuit(s) and process(es) to arbitrate between accesses to the storage that relate to its use as work group local storage (e.g. that proceed via the respective accessor circuit(s)) and access requests coming from other “requesters” to the storage. In the case where the storage is comprised of multiple banks, this arbitration is in embodiments done and provided on a bank-by-bank basis.

In this case, the system in embodiments comprises one or more arbitration circuits/processes, that are operable to and configured to receive both storage access requests relating to work group local storage regions and work group local storage, and access requests from other requester(s) (master(s)), and to arbitrate between those requests.

The arbiters (arbitration process) can be configured to operate as desired, for example to always prioritise memory access requests from “another” requester, or to always prioritise requests relating to work groups (from the clear operation circuits), as desired. There could equally be multiple other requesters able to access the storage, with appropriate arbitration (priority) policies in place accordingly.

(It would also be possible for the relative priorities of different access requests to the storage to be selectively set in use, for example by setting appropriate state (control) information for the arbitration process.)

Typically, and in some embodiments, priority is given to requests from the “another” requester. In such arrangements, in an embodiment in the case where a higher priority request from another requester is received, any transactions relating to work group processing may therefore be stalled until the other request has been serviced (and may then be resumed once this has been done).

(Correspondingly, in the case where access requests for work groups (and the clear operation circuits) have priority, then any memory access from another requester is in embodiments appropriately stalled until the request via the clear operation circuit has been serviced (and is in embodiments then resumed).)

This stalling can however mean that the accessor circuits for the different storage (memory) banks may lose synchronisation with each other. For example, if the request from the “another” requester affects only one of the storage (memory) banks, it is only memory accesses to that storage (memory) bank that will be stalled for the work group processing.

In this situation, ‘widening’ the write operation in the manner described above may not be effective since some of the storage (memory) banks may be blocked by the other requested such that the write operation cannot write to that storage (memory) bank. That is, in this situation it may not be possible to widen a write operation for an execution thread of a work group that is currently being processed by the programmable processing circuit so that all of the region is overwritten in one go since some of the storage (memory) banks may currently be blocked for such work group processing by “another” requester.

One option in this regard would therefore be to stall all memory accesses for execution threads of any work groups that are currently being executed (i.e. stall all memory accesses relating to work group processing) whenever there is a request to use any portion of the (work group local) storage made by “another” requester. This then ensures that the accessor circuits maintain synchronisation with each other.

However, this means that the work group processing may need to stall, potentially for a large number of cycles. Further, in the case where the other requester is using less than all of the (work group local) storage, this stalling is not necessary, as the work group processing could in principle continue to use any other portions of the (work group local) storage.

In another embodiment, therefore, in the situation where each bank of the storage has its own accessor circuit that maintains a queue of memory access transactions for that bank of storage (as mentioned above), when a request is made for an execution thread of a group of items to write new data to one or more entries within a respective region of the storage that has been allocated for use by the group of work items, but wherein the request is to write new data to less than all of the entries within the respective region of the storage (e.g., and in particular, when the request is to write data to less than all of the storage (memory) banks across which the region in question extends), when it is determined based on the associated indicator that the region of storage is to be cleared: the processing circuit that controls memory accesses to the storage is configured to (and the method comprises steps to: insert, into the respective queues of memory access transactions for each of the banks of storage that is not already being written to, a respective write transaction to write a clear value to the respective entries of the region of the storage that reside in those banks of storage.

In embodiments, such write transactions and inserted at the head of the respective queues of memory access transactions.

Thus, in the case that one or more of the storage (memory) banks is currently blocked for work group processing, e.g. by “another” requester, such write transaction will be the first transaction that is processed once the work group processing is resumed, thus ensuring that the region is appropriately cleared before the region is used by any other work groups. This then allows the different accessor circuits to run out of synchronisation with each other but still ensures all portions of a region of the (work group local) storage can be (and are) cleared appropriately before any region is used by any other work group.

Various arrangements be possible in this regard.

Thus, in embodiments, when a request is made for an execution thread of a group of items to write new data to a respective region of the storage that has been allocated for use by the group of work items, the processing circuit that controls memory accesses to the storage is configured to (and the method in embodiments comprises a step to) determine whether a respective indicator associated with the respective region of storage indicates that the region of storage is to be cleared.

When it is not indicated that the region of storage is not to be cleared, the new data can be (and is) written to the respective region of the storage, e.g. as normal (and the respective indicator is not updated at that point).

On the other hand, when it is determined based on the associated indicator that the region of storage is to be cleared: the processing circuit that controls memory accesses to the storage is configured to (and the method in embodiments comprises steps to)
perform a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
update the respective indicator associated with the respective region of storage so that it is no longer indicated that the region of storage is to be cleared.

In this case it will be appreciated that the updating of the respective indicator may generally take place before or after the certain set of one or more write operations has been performed.

It is believed the operation of the graphics processing system when performing this particular write operation is novel and advantageous in its own right.

Another embodiment of the technology described herein, therefore, comprises a graphics processing system, the graphics processing system comprising:
a programmable processing unit operable to execute processing programs for execution threads corresponding to work items to be processed by the graphics processing system; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be cleared;
the graphics processing system further comprising a processing circuit that controls memory accesses to the storage, the processing circuit configured to:
when a request is made for an execution thread of a group of items to write new data to a respective region of the storage that has been allocated for use by the group of work items:
determine whether a respective indicator associated with the respective region of storage indicates that the region of storage is to be cleared; and
when it is determined based on the associated indicator that the region of storage is to be cleared:
perform a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
update the respective indicator associated with the respective region of storage so that it is no longer indicated that the region of storage is to be cleared.

Correspondingly, yet another embodiment of the technology described herein comprises a method of operating a graphics processing system, the graphics processing system comprising:
a programmable processing unit operable to execute processing programs for execution threads corresponding to work items to be processed by the graphics processing system; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be cleared;
the method comprising:
when a request is made for an execution thread of a group of items to write new data to a respective region of the storage that has been allocated for use by the group of work items:
determining whether a respective indicator associated with the respective region of storage indicates that the region of storage is to be cleared; and
when it is determined based on the associated indicator that the region of storage is to be cleared:
performing a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
updating the respective indicator associated with the respective region of storage so that it is no longer indicated that the region of storage is to be cleared.

These further embodiments also extend to operation of a graphics processor as such when performing this particular write operation.

Another embodiment of the technology described herein, therefore, comprises a graphics processor, the graphics processor comprising:
a programmable processing unit operable to execute processing programs for execution threads corresponding to work items to be processed by the graphics processor; and
a processing circuit that controls memory accesses to storage in which a respective region of the storage can be allocated for temporary use by a respective group of execution threads corresponding to a group of work items being executed by the programmable processing unit while the group of execution threads are being executed, wherein respective regions of the storage are associated with respective indicators that can be used to indicate that all entries of the associated region of storage are to be cleared;
the processing circuit configured to:
when a request is made for an execution thread of a group of items to write new data to a respective region of the storage that has been allocated for use by the group of work items:
determine whether a respective indicator associated with the respective region of storage indicates that the region of storage is to be cleared; and
when it is determined based on the associated indicator that the region of storage is to be cleared:
perform a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
update the respective indicator associated with the respective region of storage so that it is no longer indicated that the region of storage is to be cleared.

Correspondingly, yet another embodiment of the technology described herein comprises a method of operating a graphics processor, the graphics processor comprising:
a programmable processing unit operable to execute processing programs for execution threads corresponding to work items to be processed by the graphics processor,
the method comprising:
when a request is made for an execution thread of a group of items to write new data to a respective region of storage that has been allocated for temporary use by a respective group of execution threads corresponding to the group of work items, wherein respective regions of the storage are associated with respective indicators that can be used to indicate that all entries of the associated region of storage are to be cleared:
determining whether a respective indicator associated with the respective region of storage indicates that the region of storage is to be cleared; and
when it is determined based on the associated indicator that the region of storage is to be cleared:
performing a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
updating the respective indicator associated with the respective region of storage so that it is no longer indicated that the region of storage is to be cleared.

As will be appreciated by those skilled in the art, these embodiments of the technology described herein can and in embodiments do include any one or more or all of the optional features of the technology described herein described herein, as appropriate. That is, the clearing process is in embodiments performed in the same way described above regardless as to whether the storage is (entirely) local to (on-chip with) the graphics processor, and in embodiments local to and on-chip with the programmable processing unit of the graphics processor, or otherwise. Various arrangements would however be possible in this regard for configuring the certain set of one or more write operations, e.g. as described above.

The use of the indicators according to the technology described herein can thus help prevent unauthorised access of a particular work group's data when the region of (work group local) storage allocated for that work group is subsequently reallocated for use by another work group.

For instance, the embodiments described above relate particularly to memory access requests that are made for an execution thread of a group of work items that is being executed by the programmable processing unit in relation to a respective region of the storage that has been allocated for use by the group of work items (i.e. a ‘valid’ (or ‘permitted’, e.g. in “bounds”) memory access request).

There may, however, still be potential security issues with different work groups that are being processed concurrently being able to access each other's allocated work group (local) storage (i.e. where the memory access is not a valid memory request (e.g. an ‘unpermitted’ or an ‘out of bounds’ memory access request)). In embodiments, therefore, a suitable (in embodiments hardware-based) “bounds check” is performed on any memory accesses to the (work group local) storage, to determine whether the memory access is being made to a region of the storage that has been allocated to a particular work group (and to prevent any accesses from another work group that is to a region of the storage that has already been allocated to a (different) work group). This then avoids memory accesses from different work groups being able to interfere with the work group local storage region that has been allocated for a particular work group.

A similar (in embodiments hardware-based) “bounds check” should be, and in embodiments is, performed in the situation where the storage is available to be used for other purposes as well as for work group local storage (i.e. in which a respective storage region can be allocated for temporary use by a respective group of execution threads corresponding to a group of work items being executed by the programmable processing unit while the group of execution threads are being executed). In that case, a “bounds check” is in embodiments performed for any memory accesses that are made by any “other” requester (i.e. a request other than a request that is made for an execution thread of a group of work items that is being executed by the programmable processing unit) to determine whether the memory access is being made to a region of the storage that has been allocated to a particular work group, and to prevent accesses from the other requested to a region of the storage that has already been allocated to a work group.

Accordingly, in an embodiment, a “bounds check” is performed on memory accesses from any “another” requester, to determine whether its memory access is being made to a region of the storage that has already been allocated to a work group for use as work group local storage or not (and to prevent any accesses from another requester that is to a region of a memory bank that has already been allocated to a work group). This would then avoid other memory accesses from other requesters being able to interfere with the work group local storage region.

Such memory region bounds checks should be, and in embodiments are, implemented by the graphics processor/system in hardware (since the programmer cannot necessarily be trusted). However, the memory region bounds checks can otherwise generally be implemented in any suitable and desired manner, for example in the normal manner for the graphics processor and graphics processing system in question.

Various arrangements would however be possible in this regard for avoiding potential interference or data leakage between the work group processing and any other processing that may also be able to use the (same) storage that can be allocated for work group local storage. For example, it would also be possible to simply block access by any other requesters to the entire work group local storage when it is being used for work group processing. Conversely, it may be possible to explicitly clear the entire region of the (work group local) storage whenever another requester requires access to that storage (and then correspondingly clear the entire region of the storage again when the other processing has finished).

To provide a further level of security (and robustness), it would also be possible to use encryption wherein different regions of the work group (local) storage (or different trust domains) are encrypted differently so that if a particular work group or other (external) “accessor” attempts to read data from a region of the work group (local) storage that has not been allocated for use by that work group or other “accessor” the data that is returned is essentially random since the accessor will not be able to decrypt the data, and in some embodiments this may be done. This then means that even if an out of bounds read were to be performed to a different region of the work group local storage (or even if the clearing process of the technology described herein fails, e.g. because of an error that flips the “clear bit” indicator), the data that is returned is not meaningful since the unauthorised access will not have the proper encryption key to be able to decode the data.

Thus, the (work group local) storage may be encrypted using a different encryption key for each different work group (or at least for each different trust domain), so that if a work group attempts to access a region of the (work group local) storage relating to a different work group (or different trust domain), the returned data cannot be decoded.

Such encryption can be done in any suitable and desired manner, e.g. by including a suitable encryption/decryption circuit in the memory access path.

Various arrangements would be possible in this regard.

The technology described herein may generally find application in any suitable graphics processing system.

The graphics processing system may further include a host processor that executes applications that can require data or graphics processing by the graphics processor and that instruct the graphics processor accordingly (e.g. via a driver for the graphics processor). The system may further include appropriate storage (e.g. memory), caches, etc.

The graphics processing system and/or graphics processor may also comprise, and/or be in communication with, one or more memories and/or memory devices that store data, and/or that store software for performing the processes described herein. The graphics processing system and/or graphics processor may also be in communication with a host microprocessor, and/or with a display for displaying images based on the data generated.

The graphics processor may include (implement) any one or more or all of the processing stages that a graphics processor (processing pipeline) can normally include. Thus, for example, the graphics processor may include a primitive setup stage, a rasteriser, and/or renderer (in embodiments in the form of a fragment shader).

The graphics processor (processing pipeline) may comprise one or more other programmable shading stages, such as one or more or all of, a vertex shading stage, a hull shader, a tessellation stage (e.g. where tessellation is performed by executing a shader program), a domain (evaluation) shading stage (shader), and a geometry shading stage (shader), as well as a fragment shader.

The graphics processor (processing pipeline) may also contain any other suitable and desired processing stages that a graphics processing pipeline may contain such as a depth (or depth and stencil) tester(s), a blender, a tile buffer or buffers, a write out unit etc.

The technology described herein can be used in and with any suitable and desired graphics processing system and processor. In one embodiment, the graphics processor (processing pipeline) is a tiled-based graphics processor (processing pipeline).

The technology described herein can be used for any form of output that a graphics processor may be used to generate. In one embodiment it is used when a graphics processor is being used to generate images for display, but it can be used for any other form of graphics processing output, such as (e.g. post-processed) graphics textures in a render-to-texture operation, etc., that a graphics processor may produce, as desired. It can also be used when a graphics processor is being used to generate other (e.g. non-image or non-graphics) outputs.

In one embodiment, the various functions of the technology described herein are carried out on a single data or graphics processing platform that generates and outputs the required data, such as processed image data that is, e.g., written to a frame buffer for a display device.

The technology described herein can be implemented in any suitable system, such as a suitably operable micro-processor based system. In some embodiments, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that the various functions, etc., of the technology described herein may be duplicated and/or carried out in parallel on a given processor. Equally, the various processing stages may share processing circuits/circuitry, etc., if desired.

Furthermore, any one or more or all of the processing stages or units of the technology described herein may be embodied as processing stage or unit circuits/circuitry, e.g., in the form of one or more fixed-function units (hardware) (processing circuits/circuitry), and/or in the form of programmable processing units/circuitry that can be programmed to perform the desired operation. Equally, any one or more of the processing stages or units and processing stage or unit circuits/circuitry of the technology described herein may be provided as a separate circuit element to any one or more of the other processing stages or units or processing stage or unit circuits/circuitry, and/or any one or more or all of the processing stages or units and processing stage or unit circuits/circuitry may be at least partially formed of shared processing circuit/circuitry.

It will also be appreciated by those skilled in the art that all of the described embodiments of the technology described herein can include, as appropriate, any one or more or all of the optional features described herein.

The methods in accordance with the technology described herein may be implemented at least partially using software, e.g., computer programs. Thus, further embodiments of the technology described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said graphics processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus further embodiments of the technology described herein comprise computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

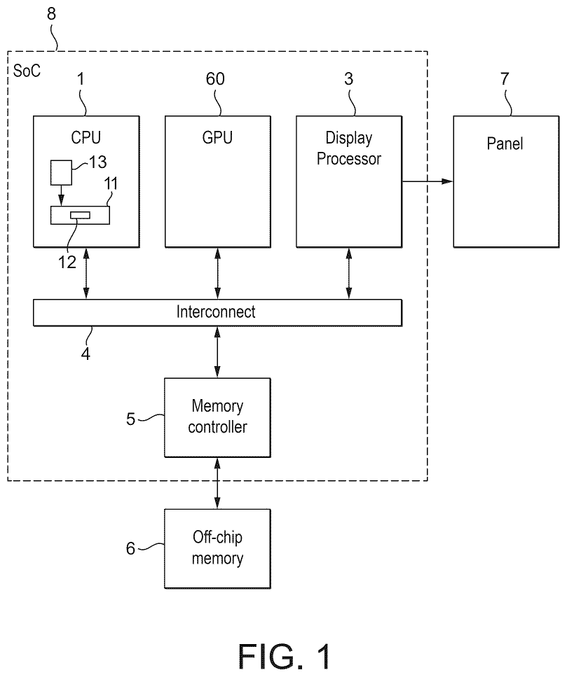

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

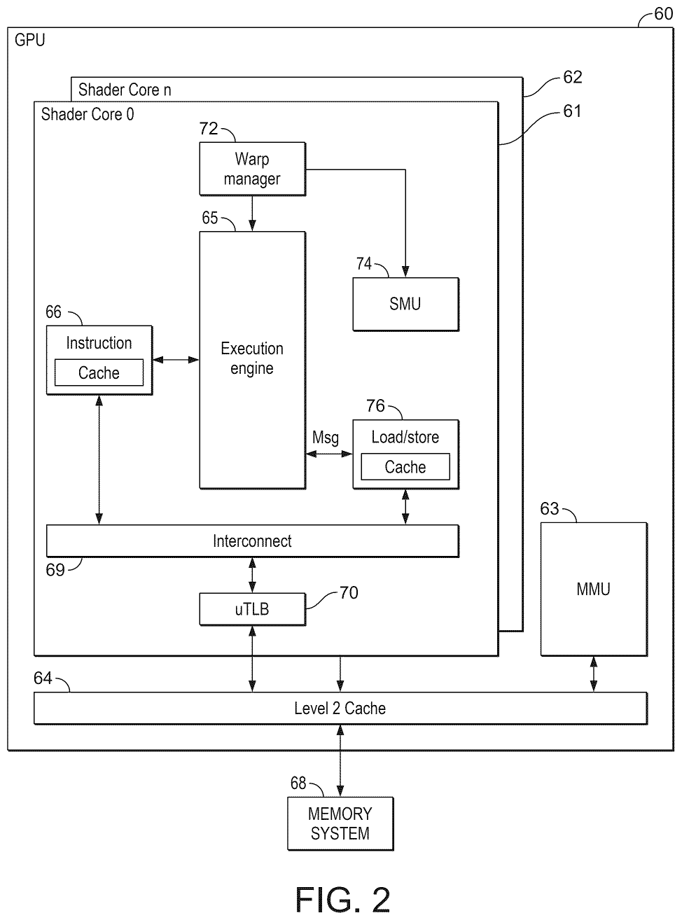

FIG. 2 shows schematically the relevant elements and components of a graphics processor (GPU) 60 of the present embodiments.

As shown in FIG. 2, the GPU 60 includes one or more programmable processing units (shader (processing) cores) 61, 62 together with a memory management unit 63 and a level 2 cache 64 which is operable to communicate with an off-chip memory system 68 (e.g. via an appropriate interconnect and (dynamic) memory controller).

FIG. 2 shows schematically the relevant configuration of one shader core 61, but as will be appreciated by those skilled in the art, any further shader cores of the graphics processor 60 will be configured in a corresponding manner.

(The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, a compute shader “work item”, etc., The shader cores will process each “item” by means of one or more execution threads which will execute the instructions of the shader program(s) in question for the “item” in question. Typically, there will be multiple execution threads each executing at the same time (in parallel).)

FIG. 2 shows the main elements of the graphics processor 60 that are relevant to the operation of the present embodiments. As will be appreciated by those skilled in the art there may be other elements of the graphics processor 60 that are not illustrated in FIG. 2. It should also be noted here that FIG. 2 is only schematic, and that, for example, in practice the shown functional units may share significant hardware circuits, even though they are shown schematically as separate units in FIG. 2. It will also be appreciated that each of the elements and units, etc., of the graphics processor as shown in FIG. 2 may, unless otherwise indicated, be implemented as desired and will accordingly comprise, e.g., appropriate circuits (processing logic), etc., for performing the necessary operation and functions.

As shown in FIG. 2, each shader core of the graphics processor 60 includes an appropriate instruction execution unit (execution engine) 65 that is operable to execute shader programs for execution threads to perform processing operations.

The shader core 61 also includes an instruction cache 66 that stores instructions to be executed by the instruction execution unit 65 to perform processing operations. The instructions to be executed will, be fetched from the memory system 68 via an interconnect 69 and a micro TLB (translation lookaside buffer) 70.

The shader core 61 also includes an appropriate load/store unit 76 in communication with the instruction execution unit 65, that is operable, e.g., to load into an appropriate cache, data, etc., to be processed by the instruction execution unit 65, and to write data back to the memory system 68 (for data loads and stores for programs executed in the instruction execution unit). Again, such data will be fetched/stored by the load/store unit 76 via the interconnect 69 and the micro TLB 70.

In order to perform graphics processing operations, the instruction execution unit 65 will execute graphics shader programs (sequences of instructions) for respective execution threads.

Accordingly, as shown in FIG. 2, the shader core 61 further comprises a warp manager 72 operable to generate execution threads for execution by the instruction execution unit 65, and to issue such threads to the instruction execution unit 65 and to control the scheduling of threads on/to the instruction unit 65, for execution.

The present embodiments are particularly concerned with the operation of the graphics processor (and in particular the shader cores of the graphics processor) when processing so called “work groups” (e.g. when performing compute shading), i.e. collections of execution threads (corresponding to respective work items) that are handled and treated as a “group” as a whole, and that are all accordingly guaranteed to exist at the same time (have the same lifetime) and are able to perform communication and synchronisation with each other. Accordingly, the warp manager 72 is correspondingly operable to generate respective work groups of execution threads, and issue and schedule such work groups of threads on and to the instruction execution unit 65.

To facilitate such work group operation, and in particular in order to facilitate data sharing between the threads within a work group, as shown in FIG. 2, the shader core 61 also includes a shared memory unit (SMU) 74, which is in communication with the instruction execution unit (execution engine) 65 and the warp manager 72.

This shared memory unit 74 is operable to provide “work group local storage” for execution threads in respective work groups, that the execution threads can read from and write to whilst the work group is being executed (while the work group is in existence), in order to allow data sharing between the threads within the work group.

In particular, respective work groups can be allocated respective memory regions within the shared memory unit for use as “work group local storage” whilst the work group is executing. When a work group reaches the end of its lifetime, the work group's “local storage” memory region in the shared memory unit 74 is de-allocated, making it available for use by another work group.

In the present embodiments, as shown in FIG. 2, the shared memory unit that provides the work group local storage is local to and on chip with the shader core 61. Other arrangements for this would, of course, be possible.

(The allocation of regions of the shared memory unit 74 to respective work groups can be performed in any suitable and desired manner, for example in the normal manner for the graphics processor and graphics processing system in question.)

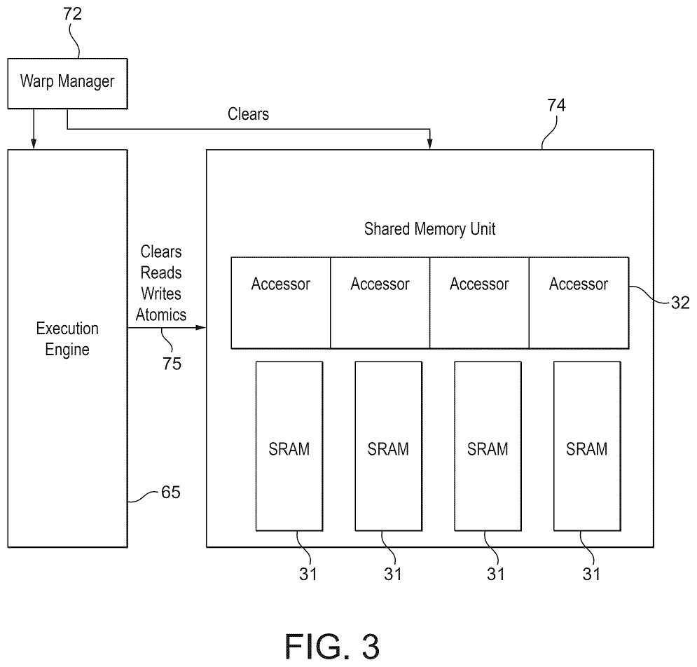

FIG. 3 shows the work group local storage shared memory unit 74 in more detail.

As shown in FIG. 3, it is assumed that the work group local storage shared memory unit 74 comprises a plurality of memory (SRAM) banks 31. FIG. 3 shows four memory banks 31, but other numbers and arrangements of memory banks would, of course, be possible.

As shown in FIG. 3 (and as discussed above in relation to FIG. 2), the work group local storage shared memory unit 74 is operable to receive “clear” commands from the warp manager 72, and also clear commands, and read and write operations, and atomic operations from the execution engine 65 (via access path 75).

As shown in FIG. 3, the work group local storage shared memory unit 74 also includes a set of memory bank access control units (circuits) 32, one for each memory bank 31. As will be discussed in more detail below, these accessor units (circuits) 32 control accesses to the memory banks 31.

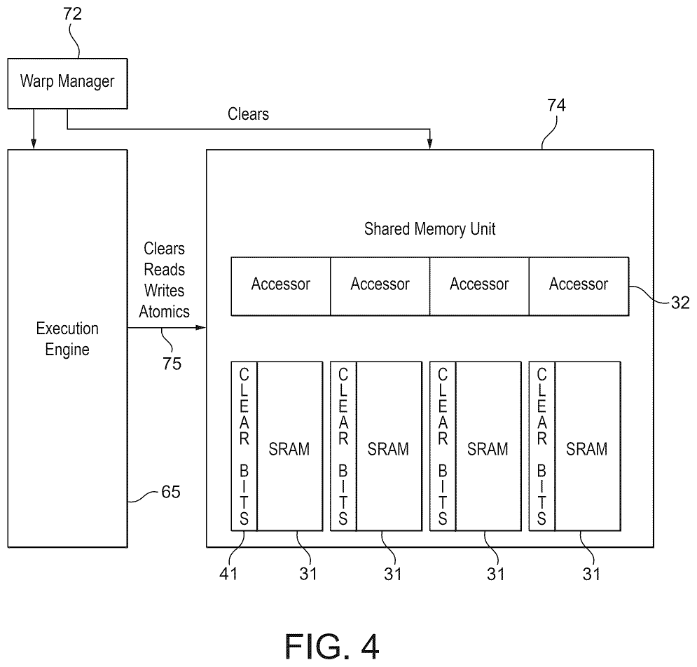

FIG. 4 shows the work group local storage shared memory unit 74 in one embodiment where respective indicators are associated with the regions of storage, the SRAM banks 31, which indicators can be used to indicate that the respective, associated region of storage is to be “cleared”.

In the present embodiments, as shown in FIG. 4, for example, the respective indicators that can be used to indicate that their associated regions of storage are to be cleared take the form of clear bits 41 associated with respective regions of the work group local storage, which clear bits 41 when set indicate that all entries within the associated region are to be cleared to a same “clear” value. The “clear” value is in embodiments given by a suitable default value. For instance, in the present embodiments, the “clear” (default) value is “zero” (although it will be appreciated that any suitable clear value or values may be used, as discussed above).

As shown in FIG. 4, in the embodiment that is shown in FIG. 4, each SRAM bank 31 has its own set of clear bits 41 such that each region within an individual SRAM bank 31 has a set of clear bits 41 that can be used to indicate whether the respective region of that SRAM bank 31 is to be cleared for the work group local storage that it is associated with.

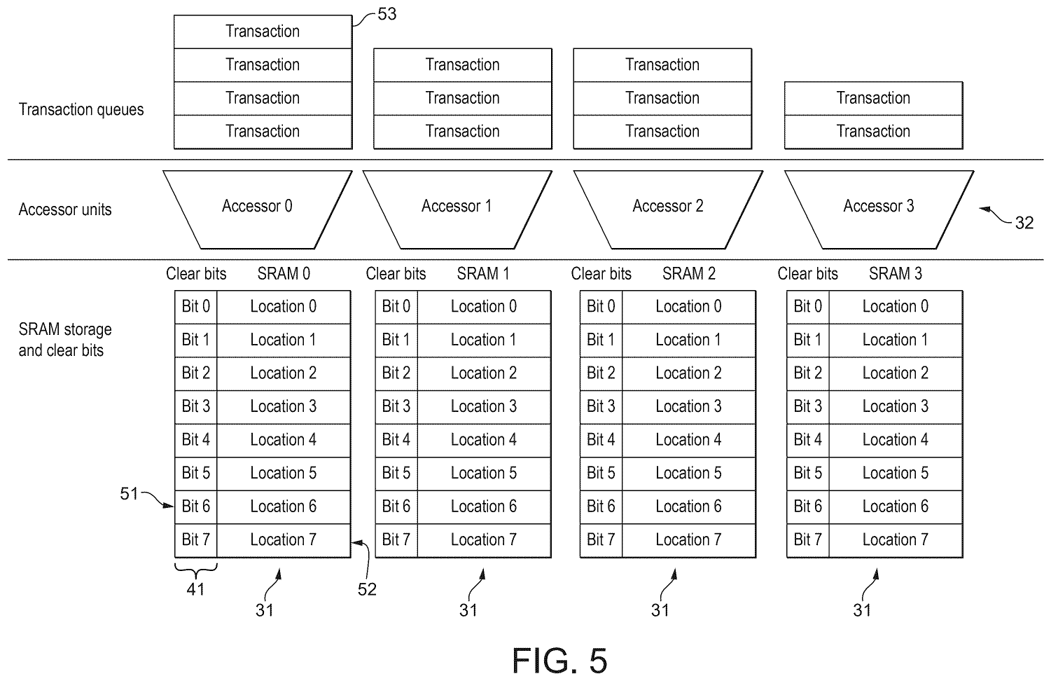

FIG. 5 shows the work group local storage shared memory unit 74 in this embodiment, i.e. where the respective indicators are associated with the regions of storage, the SRAM banks 31, in more detail.

FIG. 5 shows the SRAM banks 31 as comprising a plurality of regions (locations) 52, each region of an individual SRAM bank having associated with it a corresponding clear bit 51 of the set of clear bits 41 that each individual SRAM bank has (in this embodiment).

As discussed above, in the embodiment shown in FIG. 4 and FIG. 5 the clear bits associated with the regions of the SRAM bank indicate whether the associated region of the SRAM bank, which in this embodiment is assigned to a particular work group local storage, is to be cleared to a particular “clear” value. As mentioned above, the clear value is in the present embodiments given by a default value, for example “zero”.

FIG. 5 also shows a queue of transactions 53 for each accessor 32. The transactions 53 can be read and or write transactions for work group processing, and access the regions of storage associated with a particular work group local storage.

The transactions are facilitated by the accessors 32, which perform the (memory) transactions for work group processing, accessing the regions of the work group local storage associated with the transactions (including using the set of clear bits, as discussed below).

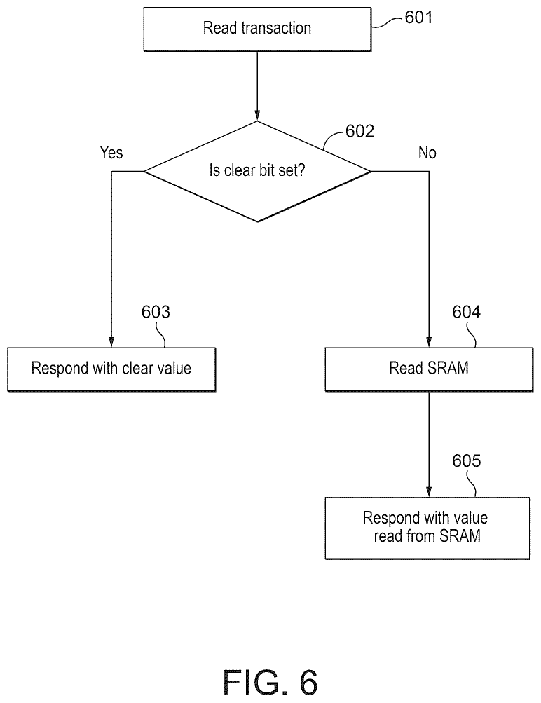

This process is discussed further in relation to FIGS. 6, 7A and 8A, for example. In particular, FIGS. 6, 7A, and 8A show processes for performing respective read or write transactions.

FIG. 6 is a flowchart showing the process for a read transaction for work group processing. In this example, the read transaction of this embodiment is to read the data values stored in a particular region of an SRAM bank associated with a work group local storage, the region having associated with it a particular clear bit value.

As shown in FIG. 6, for a given read transaction to be processed (step 601) it is first determined whether the clear bit is set (step 602).

For example, referring again to the embodiment shown in FIG. 4 and FIG. 5, in this embodiment, the clear bit (in this embodiment) is associated with a region of an individual region of an SRAM bank and indicates whether the associated region of the SRAM bank is to be cleared. Thus, the read transaction that is being processed (i.e. starting at step 601) may be being processed by the respective accessor 32 for a particular one of the SRAM banks 31.

Hence, if it is determined that the clear bit is set (step 602—Yes), i.e. if the clear bit indicates that the region of the SRAM bank that the read transaction is trying to read from indicates that the region is to be cleared (e.g. the clear bit is set), then the read transaction is serviced by responding with a suitable clear value (step 603). For example, as described above, in this embodiment, the clear value is in embodiments a default value (e.g. zero), and so in this example, when it is determined that the clear bit is set (i.e. step 602—Yes), the default value is then returned in response to the read transaction. Accordingly, the region of the SRAM bank associated with that clear bit value for the read transaction is notionally cleared as a common default data value will be (and is) returned for each entry in the region being read by the transaction (i.e. rather than returning the underlying data values stored in that region of the SRAM bank).

If, however, it is determined that the clear bit is not set (step 602—No), i.e. the clear bit indicates that the region of the SRAM bank that the read transaction is trying to read from indicates that the region is not to be cleared, then the read transaction is serviced by reading the requested entries within the SRAM region in question (step 604), and returning in response to the read transaction the data values that are stored in those entries within the SRAM bank.

FIG. 6 accordingly shows the process of reading the data values stored in a region of an SRAM bank, the regions of an SRAM bank each being associated with a particular clear bit. As discussed, the regions of the SRAM bank are associated with a particular work group local storage, and the process of FIG. 6 shows using the clear bits in a read transaction of a region of a particular work group local storage. This process can, for example, be implemented by the accessors 32 when performing a transaction 53.

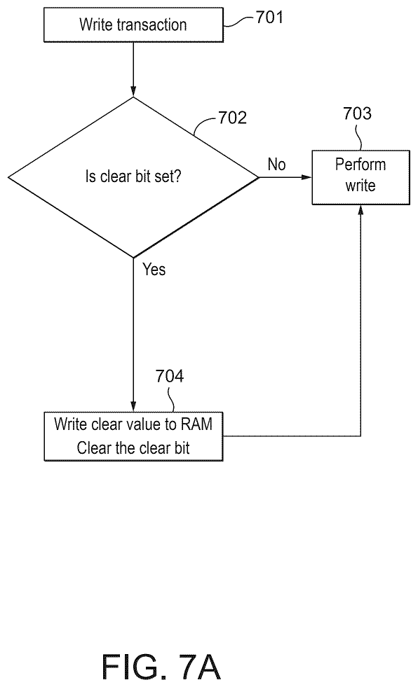

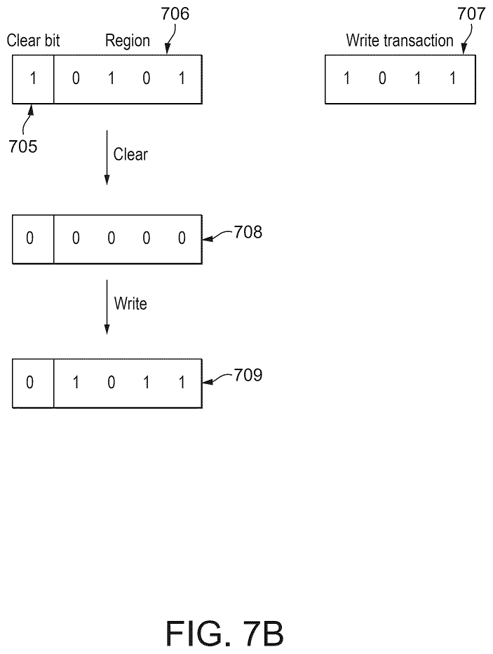

FIG. 7A is a flow chart showing an embodiment of a process for a write transaction for writing to a region of an SRAM bank, the region being a part of a work group local storage that the transaction is for, the region having associated with it a clear bit indicating whether the region is to be cleared.

For a given write transaction for writing data to a region of an SRAM bank, the region of the SRAM bank having associated with it a clear bit value, the write transaction (step 701) considers whether the clear bit is set (step 702), i.e. whether the clear bit indicates that the region of the SRAM bank that the write transaction is trying to write to is to be cleared.

If the clear bit is not set (step 702—No), i.e. the region of the SRAM bank for the write transaction is not being indicated as having to be cleared by the clear bit, then the write transaction process moves to perform the write transaction (that is to write the data values of the write transaction into the region of the SRAM bank (for which the clear bit is associated with)).

If, however, the clear bit is set (step 702—Yes), i.e. the clear bit indicates that the region of the SRAM bank that the write transaction is trying to write to is to be cleared, then the write transaction process of this embodiment proceeds to:
write a default value, given by the clear bit value or otherwise, into the region of the SRAM bank that the write transaction is trying to write to (and associated with the clear bit), such that each data value of that region is now given by the default value;
and to clear the clear bit (that is, change the clear bit value so that it does not indicate that that the region of the SRAM bank that the write transaction is trying to write to is to be cleared) (step 704).

Following this, the process carries on to perform the write transaction (step 703) as discussed above.

The flowchart of FIG. 7A thus shows that if the clear bit for a region is set then, in this embodiment, each data value of the region is replaced with a default value, clearing the data values that were in the region prior to the write transaction.

FIG. 7B is an illustrative (simplified) example of implementing the process of FIG. 7A. Thus, FIG. 7B shows a write transaction 707 for writing to a region of an SRAM bank 706, the region 706 having a respective clear bit 705 which indicates whether the region is to be cleared. In this example, the clear bit 705 is set to indicate that the region 706 is to be cleared. As such, the write process writes the default value (zero) to all of the entries within the region 708, and the clear bit is cleared. The region is then cleared at this point (cleared region 708).

Then, the data values given by the write transaction given by write transaction 707 are written into the region that the transaction is accessing, resulting in written region 709.

Thus, in the example shown in FIG. 7A and FIG. 7B, the write transaction to a region for which the clear bit is set to indicate that the region should cleared is serviced by performing two write operations; a first write operation involving explicitly writing the default value to all entries within the region (i.e. at step 704); and a second write operation that then writes the new data as requested.

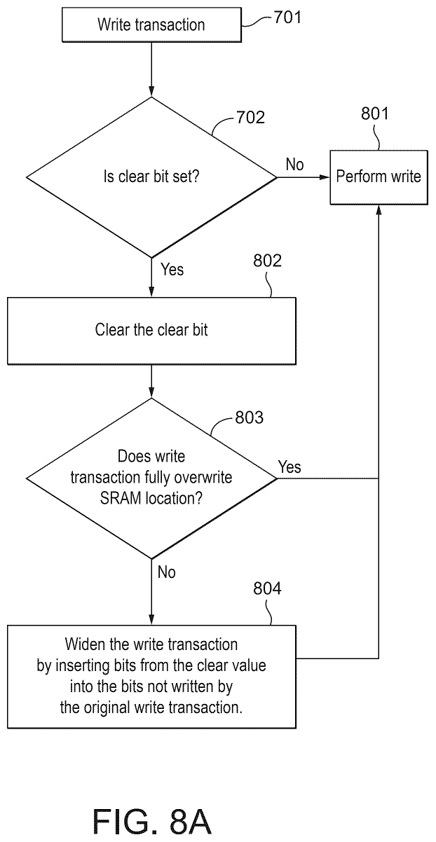

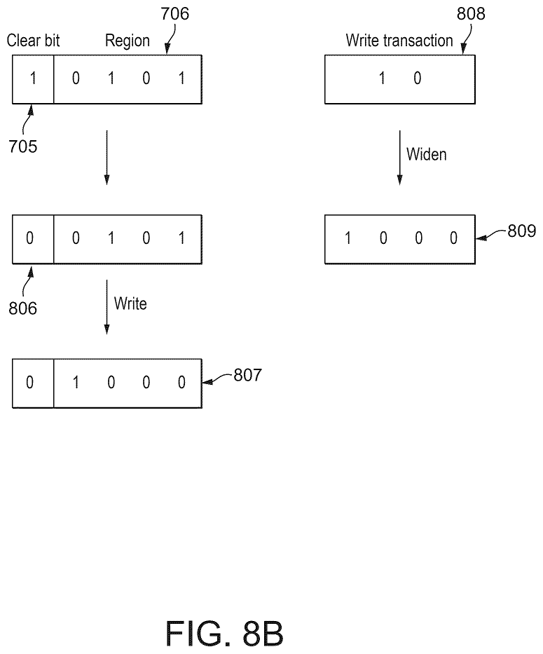

FIG. 8A shows a flow chart for performing a write transaction for writing data values to a region of an SRAM bank, the region having associated with it a clear bit indicating whether the region is to be cleared, according to another embodiment, in which the write transaction to a region for which the clear bit is set to indicate that the region should cleared is serviced by a single write operation.

As can be seen from FIG. 8A, the write transaction process starts similarly to that of FIG. 7A. That is, the write transaction begins (step 701) and it is determined whether the clear bit is set (step 702).

If the clear bit is not set (step 702—No), then the process moves onto performing the write transaction (step 801), writing the desired data values of the write transaction into the respective region of the SRAM bank (that is associated with the clear bit), e.g. as normal.

On the other hand, if the clear bit is set (step 702—Yes), then the clear bit is then cleared so that the clear bit value does not indicate that that the region of the SRAM bank that the write transaction is trying to write to is to be cleared (step 802).

Following this, the process then determines whether the write transaction would fully overwrite the SRAM region (step 803). That is, whether the number of data values that the write transaction is to write into the region of the SRAM bank is the same as the number of entries in the region of the SRAM bank (so that the write transaction provides a data value for entry of the region to be written to).

If the write transaction does fully overwrite all entries of the SRAM bank in question (step 803—Yes), then the write transaction is performed (step 801), writing the data values of the write transaction to the region of the SRAM bank.

If, however, the write transaction does not fully overwrite the SRAM entry (step 803—No) (such that if the write transaction were to be performed there would be data values of the region that do not have a corresponding data value of the write transaction), then the write transaction is widened by inserting bits (e.g. the default value, or otherwise), into the bits not written by the write transaction (step 804).

For instance, the write transaction itself can be widened such that it writes to all entries within the region in question e.g., by inserting additional data values into the write transaction to cause the write transaction to write the default value (e.g. to write) zero to any entries within the region that are not written to by the original write transaction. Once the write transaction has been suitably widened to write to all entries within the region in question, the write transaction is then performed (step 801). The effect of this is therefore that all entries of the region are overwritten (either with new data or with the default value) in one go.

FIG. 8A thus shows an embodiment of a write transaction where, if the clear bit is set, the memory transaction is widened to ensure all the data values of the region that the memory transaction is writing to are overwritten by the memory transaction.

FIG. 8B shows an illustrative (simplified) example of implementing the write transaction process of FIG. 8B for a write transaction 808 writing to a region 706, the region having a clear bit 705. As shown in FIG. 8B, in this example, the clear bit 705 associated with the region that is being written to is set, and so the clear bit is first cleared to clear bit 806.

In the example shown in FIG. 8B, the original write transaction 808 only comprises two data values, that will be written to the first two entries within the region. As such, the original write transaction 808 would not fully overwrite the region, as the region comprises four data values.

Therefore, as shown in FIG. 8B, the write transaction can be widened by appending two additional data values to the end of the transaction (or otherwise, as appropriate), the additional data values having the value of the default value (in this example, zero), so that the widened transaction 809 has the same number of data values as the region 706 (so that when it is written into the region each data value of the region is overwritten by the write transaction as each data value of the region has a corresponding data value in the write transaction).

The data values of the widened write transaction 809 are then written into the region to give written region 807.

(It will be appreciated that for illustrative purposes FIGS. 7B and 8B show a simplified example where a single bit is written to each entry within the region. In practice, each entry within a region may be able to store data values of any suitable and desired size.)

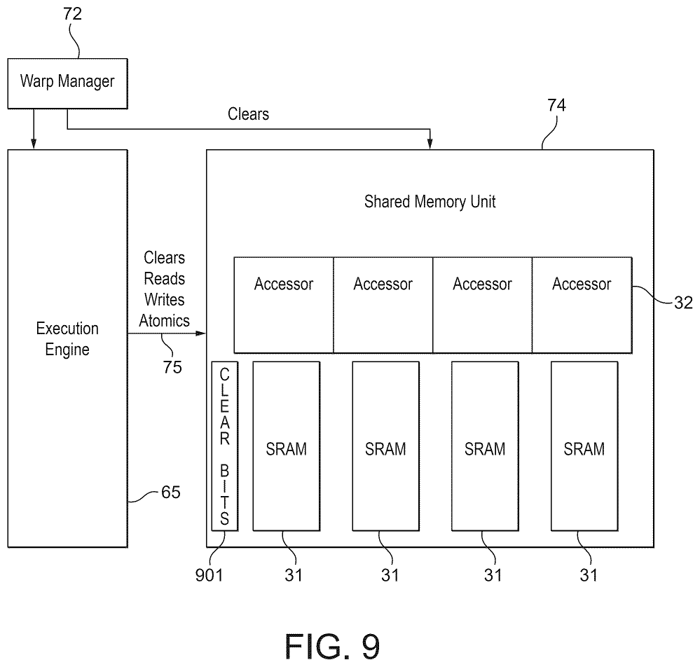

Considering briefly, again, FIG. 5, the processes described in relation to FIGS. 6, 7A, and 8A can in some embodiments be implemented by the accessors 32. That is to say, the accessors 32, when performing transactions 52, can consider the clear bit value 51 associated with a region 52 of the SRAM banks 31 that the transaction is accessing and return the respective result when reading (e.g. as discussed in relation to FIG. 6), or write the data values of the transaction to that region (based on the value of the clear bit 51) (as discussed in relation to FIG. 8 or 9). Various arrangements would however be possible in this respect.

FIG. 9 shows another embodiment of the work group local storage shared memory unit 74 with an alternative arrangement of clear bits and SRAM banks.

In the embodiment of FIG. 9, the set of clear bits 901 covers respective regions of the SRAM banks that extend across multiple (all) of the SRAM banks, such that a single clear bit of the set of clear bits 901 can act as a respective indicator for indicating whether a region is to be cleared for regions extending across multiple (all) of the SRAM banks.

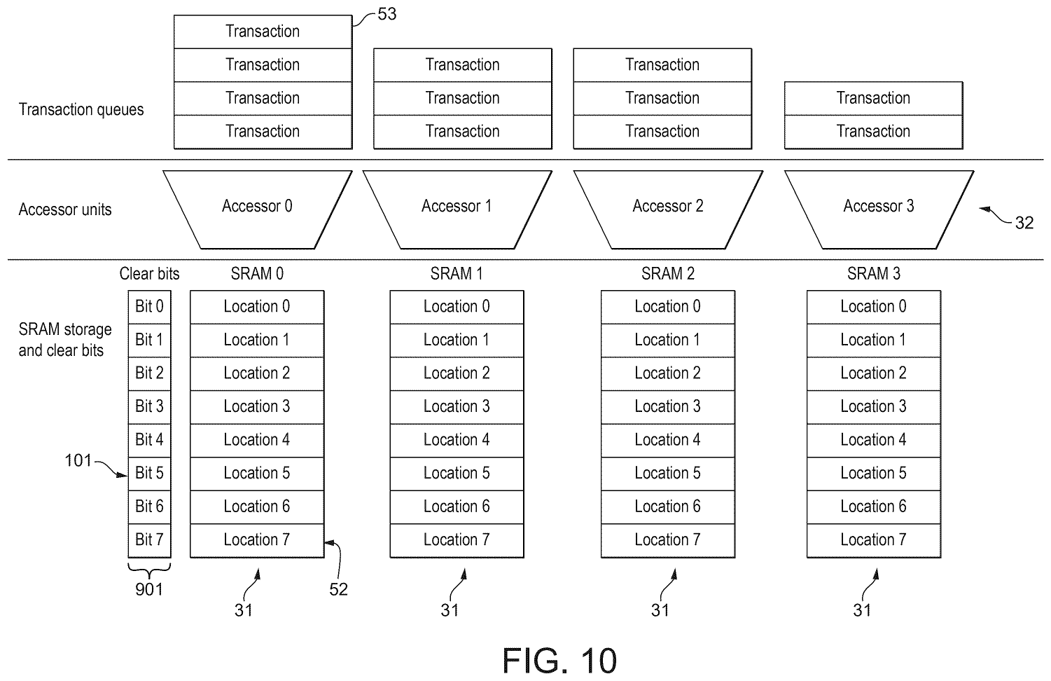

FIG. 10 shows the set of clear bits 901 covering respective regions of the SRAM banks that extend across multiple (all) of the SRAM banks in more detail.

For instance, as can be seen in FIG. 10, each SRAM bank 31 comprises a number of regions 52 and the set of clear bits 901 comprises a number of clear bits 101.

In FIG. 10, each clear bit of the set of clear bits is associated with a number of regions of the SRAM banks that extends across multiple (all) SRAM banks. That is, one clear bit of the set of clear bits can act as an indicator as to whether the regions of the SRAM banks that the clear bit is associated with are to be cleared, said regions extending across multiple (all) SRAM banks 31.

In an example, clear bit 0 can act as such an indicator for entry 0 of SRAM banks 1 to 4, those entries making up a work group local storage. As discussed, the clear bits 101 are used in respective (read or write) transactions 53 for work group processing.

The accessors 32 of FIG. 10 work similarly to those described in relation to FIG. 5. However, for a transaction 53 the accessor, when performing said transaction, will consider the clear bit 101 in the set of clear bits 901 that is associated with the (entire) region of the SRAM banks 31 that the transaction is accessing, said clear bit acting as an indicator as to whether the region is to be cleared as well as the same indicator for other regions extending across multiple (all) SRAM banks (said regions forming a work group local storage).

A read transaction for the clear bit and SRAM region arrangements of FIGS. 9 and 10 corresponds to that described in relation to FIG. 6. However, for a read transaction for reading data values from a region of a SRAM bank, the process considers in step 602 whether the clear bit is set, the clear bit being the clear bit associated with said region of the SRAM bank, as well as other regions of other SRAM banks.

This can be done by the accessor 32 performing the transaction 53, or otherwise, as appropriate.

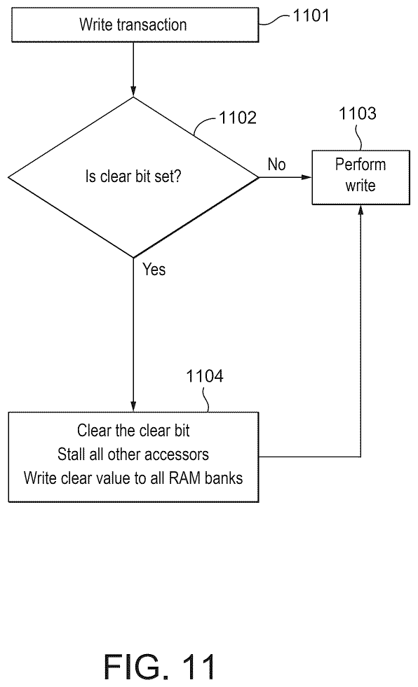

FIG. 11 is a flowchart for a write transaction for writing to a region of a SRAM bank having a clear bit value associated with multiple regions of SRAM banks (as shown in FIGS. 9 and 10).

FIG. 11 shows, for a write transaction (1101) that the process first considers whether the clear bit is set (step 1102), that is whether the clear bit indicates that the regions that it is associated with are to be cleared.

If the clear bit is not set (step 1102—No), i.e. does not indicate that indicates that the regions that it is associated with are to be cleared, then the write transaction is performed (step 1103) and the data values of the write transaction are written to the respective region that the write transaction is for.

If, however, the clear bit is set (step 1101—Yes), such that the clear bit indicates that the regions that it is associated with are to be cleared, then the clear bit is cleared (set such that it indicates that the regions that it is associated with are not to be cleared), the accessors other than the accessor performing the write transaction are stalled (to prevent access to the SRAM banks by the accessors) and the data values in the regions associated with the clear bit value are all overwritten with the default value (given by e.g. the clear bit value, or otherwise) (step 1104). Following this, the write transaction is performed (step 1103).

FIG. 11 accordingly shows the write transaction for writing to a region of an SRAM bank (the region being part of a workgroup local storage). If the clear bit associated with the region of the SRAM bank is set, then the process of FIG. 11 shows overwriting all the data values of (all) the regions that the clear bit is associated with, clearing the data values of those regions.

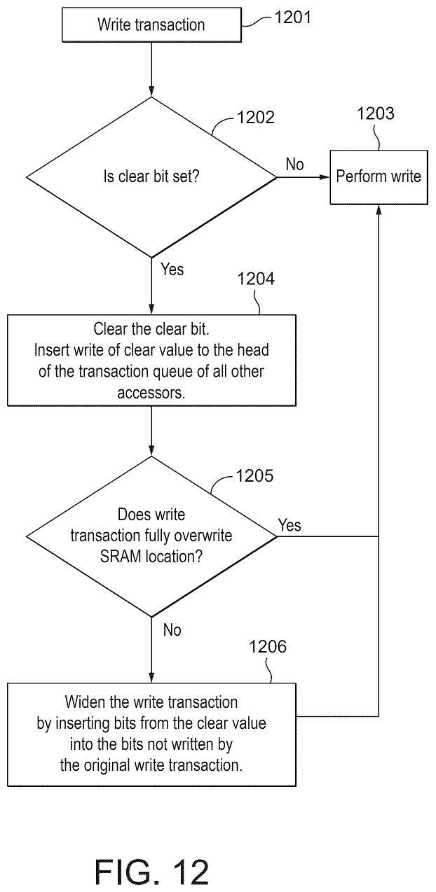

FIG. 12 shows an alternative process for performing a write transaction to a region of an SRAM bank, the region of the SRAM bank having associated with it a clear bit value, the clear bit value being associated with multiple regions spanning multiple SRAM banks.

For a write transaction for writing to a region of an SRAM bank (step 1201), the process of FIG. 12 considers whether the clear bit is set (as discussed above) (step 1202).

If the clear bit is not set (step 1202—No), then the write transaction is performed (step 1203), and the data values of the write transaction are written to the data values of the region that the write transaction is writing to and that is associated with the clear bit value.

If the clear bit is set (step 1202—Yes), then the bit is cleared (set such that is does not indicate that the regions that it is associated with are to be cleared), and additional write transactions are inserted at the head of the transaction queue of (all) the accessors, other than the accessor performing the write transaction 1201, the additional write transactions writing the default value to all data values of the regions associated with the set clear bit value (such that when all the additional write transactions are performed the regions, other than the region written to by memory transaction 1201, associated with said clear bit value (all regions forming part (all) of a work group local storage) are cleared) (step 1204).

Following this, it is considered whether the write transaction fully overwrites the region of the SRAM bank that it is writing to (step 1205).

If the write transaction fully overwrites the region of the SRAM bank that it is writing to (step 1205—Yes), then the write transaction is performed (step 1203).

If the write transaction does not fully overwrites the region of the SRAM bank that it is writing to (step 1205—No), then the write transaction is widened by inserting bits given by the default value into the bits of the memory transaction (step 1206), so that the memory transaction has a number of data values equal to that of the region that is being written to so that each data value in that region is overwritten by the memory transaction. Following this, the write transaction is performed (step 1203).

FIG. 12 thus described a write transaction for writing data values to a region of an SRAM bank, the region has associated with it a clear bit that is also associated with multiple other regions spanning multiple SRAM banks. The process of FIG. 12 ensures that all regions associated with a clear bit value (forming a work group local storage) are cleared in following write transactions by placing write transactions into the head of each other accessor so that the regions associated with the same clear bit considered in the transaction of FIG. 12 that are not being overwritten by the memory transaction performed in the process of FIG. 12 are cleared in subsequent write transactions. FIG. 12 also uses a similar process to that described in relation to FIGS. 8A and 8B, where the memory transaction (for a particular bank) is widened to ensure it overwrites each data value of the region it is writing to.

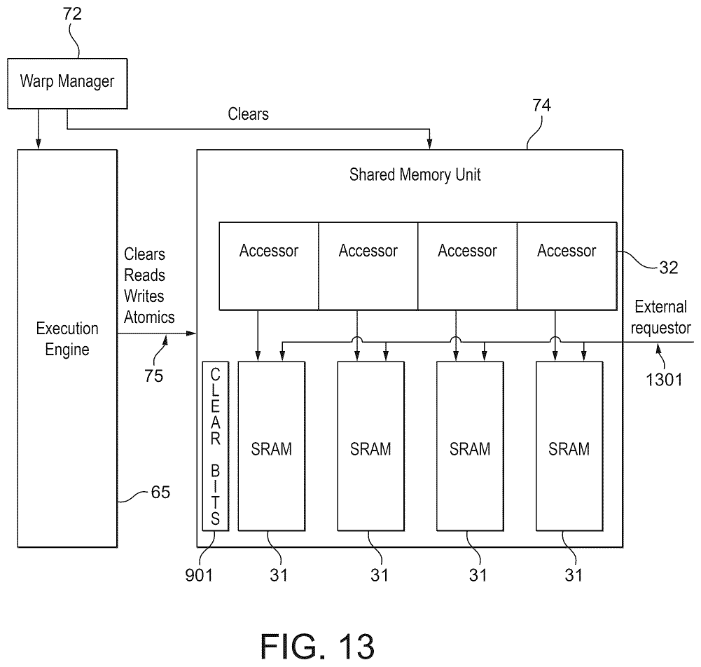

FIG. 13 shows an embodiment of the work group local storage shared memory unit 74 of FIG. 9 but where the SRAM banks can be accessed by an external requester 1302.

In the embodiment of FIG. 13, the SRAM banks 31 being used as the “work group local storage”, is also available to be used for other purposes (e.g. for other processes that the graphics processor 60 may perform). There is therefore an external requestor 1301 that attempts to access the storage of the SRAM banks 31.

When a transaction to access the storage of the SRAM banks comes in from the external requestor 1301, in this embodiment, it is given priority over the transactions to access the SRAM banks coming from work group processing requests.

That is, the request from the external requestor 1301 will be given priority over the particular entry (region) that it is requesting access to, so that the request from the external requestor 1301 blocks access to that entry for work group processing. If the external requestor 1301 is only requesting access to less than all of the region available in the SRAM banks (e.g. only to a single storage (memory) bank), the rest of the storage can still be used for work group local storage. However, it could also be the case that whenever a request to use part of the (work group local) storage is made by the external requestor 1301, the entire (work group local) storage (the SRAM banks 31) is blocked for work group processing until the external requestor 1301 has finished using the storage.

Regardless, the transactions from the external requestor 1301 are still restricted from accessing the regions of the SRAM banks that are assigned to the work group local storage to prevent the external requestor 1301 from reading and/or writing data values to/from those regions.

To prevent this “unauthorised access”, a (hardware-based) “bounds check” is performed on any memory accesses to the SRAM banks 31 coming from the external requestor 1301 to determine whether the memory access is being made to a region of the storage that has been allocated to a particular work group; thereby avoiding memory accesses from the external requestor 1301 being able to interfere with the work group local storage region that has been allocated for a particular work group. Such memory region bounds checks could be implemented in any suitable and desired manner, for example in the normal manner for the graphics processor and graphics processing system in question.

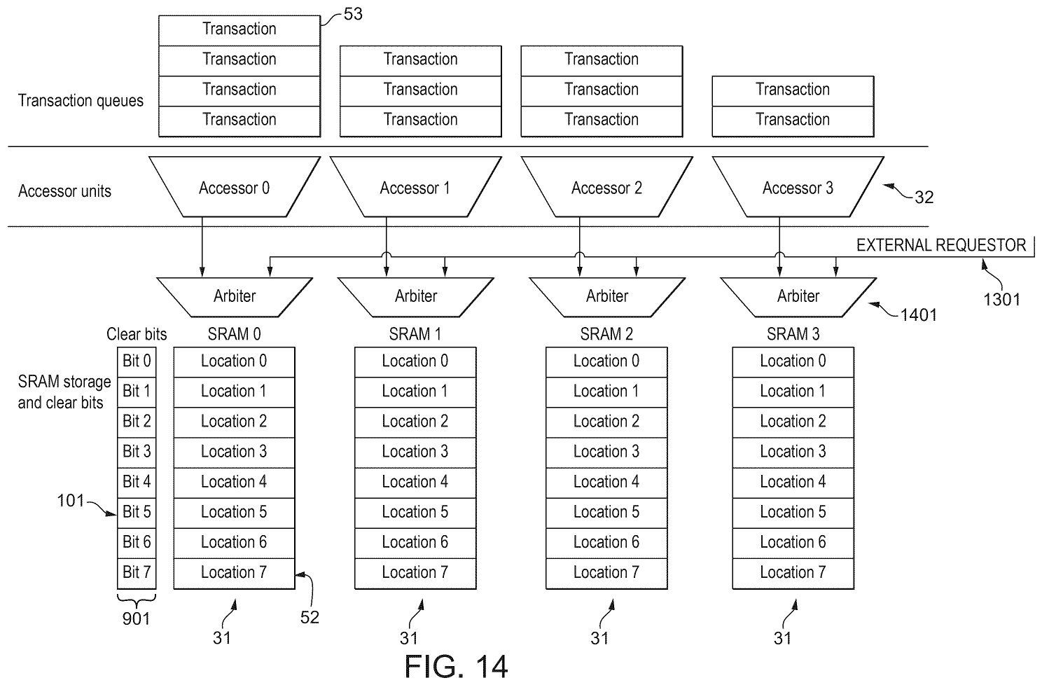

FIG. 14 shows a more detailed arrangement and embodiment in which the work group local storage is able to be accessed by an external requester 1301 that is able to make accesses to the SRAM 31 banks of the shared memory unit 74.

In this case, accordingly, there are a set of arbiters (arbitration circuits) 1401 that are operable to arbitrate between memory access requests coming from the external requestor 1301 and from the work group local storage accessor units 32.

In this arrangement, the arbiters 1401 can be configured to operate as desired, for example to always prioritise memory access requests from the external requestor 1301, or to always prioritise requests from the accessors 32, as desired. There could equally be multiple other requesters able to access the memory, with appropriate arbitration (priority) policies in place accordingly.

In this arrangement, in the case where a higher priority request from the external requestor 1301 is received, the memory access from the corresponding accessors will be appropriately stalled until the external request has been serviced, and may then be resumed (and vice versa).

That is, the arbiters 1401, or otherwise, can stall the transactions 53 coming from work group processing until the external requestor 1301 has completed its accessing of the SRAM banks 31.

Although FIG. 14 shows the use of arbiter circuits 1401 to control access conflicts between other requesters and the accessors, it would also be possible for any access requests from the external requestor 1301 to pass via the accessors 32 if desired. Again, the accessors could be configured to prioritise requests from external requesters (or not), if desired.

In this case, the accessors in embodiments handle any memory access requests from external requesters (subject to any priority ranking) in the same way as they do for other memory access requests from the execution engine, i.e. to determine whether the memory access request from an external requester is to a region that is still to be cleared, and then, if so, to appropriately stall that memory access request from the external requester until the region has been cleared (as discussed above in relation to FIGS. 6 and 7, for example).

It can be seen from the above, that the technology described herein, in its embodiments at least, can provide improved operations and implementation when using work group local storage for work groups being executed by a programmable processing unit of a graphics processor. This is achieved, in the embodiments of the technology described herein at least, by using clear bits to indicate whether respective regions of work group local storage are to be cleared when performing read and or write transactions on those regions.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A graphics processing system, the graphics processing system comprising:
a programmable processing unit operable to execute processing programs for execution threads corresponding to work items to be processed by the graphics processing system; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be cleared;
the graphics processing system further comprising a processing circuit that controls memory accesses to the storage, the processing circuit configured to:
when a request is made for an execution thread of a group of work items that is being executed by the programmable processing unit to read data from a respective region of the storage that has been allocated for use by the group of work items:
determine whether a respective indicator associated with the respective region of storage indicates that the region of storage is to be cleared; and
when it is determined based on the associated indicator that the region of storage is to be cleared, return a clear value in response to the request to read the data from the region of storage.

2. The graphics processing system of claim 1, wherein when a request is made for an execution thread of a group of items to write new data to a respective region of the storage that has been allocated for use by the group of work items, the processing circuit that controls memory accesses to the storage is configured to:
determine whether a respective indicator associated with the respective region of storage indicates that the region of storage is to be cleared; and
when it is determined based on the associated indicator that the region of storage is to be cleared:
perform a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
update the respective indicator associated with the respective region of storage so that it is no longer indicated that the region of storage is to be cleared.

3. The graphics processing system of claim 1, wherein when a request is made for an execution thread of a group of items to write new data to one or more entries within a respective region of the storage that has been allocated for use by the group of work items, but wherein the request is to write new data to less than all of the entries within the respective region of the storage, when it is determined based on the associated indicator that the region of storage is to be cleared: the processing circuit that controls memory accesses to the storage is configured to perform a write operation that writes the new data to the requested entries within the region of the storage and also writes a clear value to all other entries within the region of the storage.

4. The graphics processing system of claim 1, wherein the storage is configured as multiple, independently accessible banks, and the respective indicator are associated with respective regions of the storage that extend across multiple of the independently accessible banks.

5. The graphics processing system of claim 4, wherein each bank of the storage has its own accessor circuit that maintains a queue of memory access transactions for that bank of storage, and wherein when a request is made for an execution thread of a group of items to write new data to one or more entries within a respective region of the storage that has been allocated for use by the group of work items, but wherein the request is to write new data to less than all of the entries within the respective region of the storage, when it is determined based on the associated indicator that the region of storage is to be cleared: the processing circuit that controls memory accesses to the storage is configured to: insert, into the respective queues of memory access transactions for each of the banks of storage that is not already being written to, a respective write transaction to write a clear value to the respective entries of the region of the storage that reside in those banks of storage.

6. The graphics processing system of claim 1, wherein the storage is available to be used for other purposes as well as storage in which a respective storage region can be allocated for temporary use by a respective group of execution threads corresponding to a group of work items being executed by the programmable processing unit while the group of execution threads are being executed; and
the system further comprises: one or more arbitration circuits configured to receive both storage access requests relating to work group storage regions, and access requests from other requester(s), and to arbitrate between those requests.

7. The graphics processing system of claim 1, wherein the respective indicators comprise respective bits that can be set or cleared to indicate whether or not the associated region is to be cleared to zero.

8. The graphics processing system of claim 1, wherein a respective indicator is set to indicate that an associated region of the storage is to be cleared in response to allocation of the region of the storage to a new work group from a different trust domain.

9. The graphics processing system of claim 1, wherein the programmable processing unit is part of a graphics processor, and wherein the storage is local to and on-chip with the programmable processing unit of the graphics processor.

10. A graphics processing system, the graphics processing system comprising:
a programmable processing unit operable to execute processing programs for execution threads corresponding to work items to be processed by the graphics processing system; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be cleared;
the graphics processing system further comprising a processing circuit that controls memory accesses to the storage, the processing circuit configured to:
when a request is made for an execution thread of a group of items to write new data to a respective region of the storage that has been allocated for use by the group of work items:
determine whether a respective indicator associated with the respective region of storage indicates that the region of storage is to be cleared; and
when it is determined based on the associated indicator that the region of storage is to be cleared:
perform a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
update the respective indicator associated with the respective region of storage so that it is no longer indicated that the region of storage is to be cleared.

11. The graphics processing system of claim 10, wherein when a request is made for an execution thread of a group of items to write new data to one or more entries within a respective region of the storage that has been allocated for use by the group of work items, but wherein the request is to write new data to less than all of the entries within the respective region of the storage, when it is determined based on the associated indicator that the region of storage is to be cleared: the processing circuit that controls memory accesses to the storage is configured to perform a write operation that writes the new data to the requested entries within the region of the storage and also writes a clear value to all other entries within the region of the storage.

12. The graphics processing system of claim 10, wherein the storage is configured as multiple, independently accessible banks, and the respective indicator are associated with respective regions of the storage that extend across multiple of the independently accessible banks.

13. The graphics processing system of claim 12, wherein each bank of the storage has its own accessor circuit that maintains a queue of memory access transactions for that bank of storage, and wherein when a request is made for an execution thread of a group of items to write new data to one or more entries within a respective region of the storage that has been allocated for use by the group of work items, but wherein the request is to write new data to less than all of the entries within the respective region of the storage, when it is determined based on the associated indicator that the region of storage is to be cleared: the processing circuit that controls memory accesses to the storage is configured to: insert, into the respective queues of memory access transactions for each of the banks of storage that is not already being written to, a respective write transaction to write a clear value to the respective entries of the region of the storage that reside in those banks of storage.

14. The graphics processing system of claim 10, wherein the storage is available to be used for other purposes as well as storage in which a respective storage region can be allocated for temporary use by a respective group of execution threads corresponding to a group of work items being executed by the programmable processing unit while the group of execution threads are being executed; and
the system further comprises: one or more arbitration circuits configured to receive both storage access requests relating to work group storage regions, and access requests from other requester(s), and to arbitrate between those requests.

15. The graphics processing system of claim 10, wherein the respective indicators comprise respective bits that can be set or cleared to indicate whether or not the associated region is to be cleared to zero.

16. The graphics processing system of claim 10, wherein a respective indicator is set to indicate that an associated region of the storage is to be cleared in response to allocation of the region of the storage to a new work group from a different trust domain.

17. The graphics processing system of claim 10, wherein the programmable processing unit is part of a graphics processor, and wherein the storage is local to and on-chip with the programmable processing unit of the graphics processor.

18. A method of operating a graphics processing system, the graphics processing system comprising:
a programmable processing unit operable to execute processing programs for execution threads corresponding to work items to be processed by the graphics processing system; and
storage in which a respective region of the storage can be allocated for temporary use by a respective group of execution threads corresponding to a group of work items being executed by the programmable processing unit while the group of execution threads are being executed,
wherein respective regions of the storage are associated with respective indicators that can be used to indicate that all entries of the associated region of storage are to be cleared;
the method comprising:
when a request is made for an execution thread of a group of work items that is being executed by the programmable processing unit to read data from a respective region of the storage that has been allocated for use by the group of work items:
determining whether a respective indicator associated with the respective region of storage indicates that the region of storage is to be cleared; and
when it is determined based on the associated indicator that the region of storage is to be cleared, returning a clear value in response to the request to read the data from the region of storage.

19. The method of claim 18, wherein when a request is made for an execution thread of a group of items to write new data to a respective region of the storage that has been allocated for use by the group of work items, the method comprises:
determining whether a respective indicator associated with the respective region of storage indicates that the region of storage is to be cleared; and
when it is determined based on the associated indicator that the region of storage is to be cleared:
performing a certain set of one or more write operations in such a manner that the new data is written to the respective region of the storage as requested whereas a clear value is written to all other entries if any, within the respective region of the storage, the result of the certain set of one or more write operations thus being to overwrite all of the region either with new data or with a clear value; and
updating the respective indicator associated with the respective region of storage so that it is no longer indicated that the region of storage is to be cleared.

20. The method of claim 18, wherein when a request is made for an execution thread of a group of items to write new data to one or more entries within a respective region of the storage that has been allocated for use by the group of work items, but wherein the request is to write new data to less than all of the entries within the respective region of the storage, when it is determined based on the associated indicator that the region of storage is to be cleared: the method comprises performing a write operation that writes the new data to the requested entries within the region of the storage and also writes a clear value to all other entries within the region of the storage.
